(19) United States
(12) Patent Application Publication
(10) Pub. No.: US 2022/0395978 A1
(43) Pub. Date: Dec. 15, 2022

(54) ENHANCED ROBOTIC CAMERA CONTROL

(71) Applicant: Sisu Devices LLC, Round Rock, TX (US)

(72) Inventors: Vallan Sherrod, Round Rock, TX (US); Jacob Robinson, Round Rock, TX (US); Spencer Hogge, Round Rock, TX (US); Jon Terry, Round Rock, TX (US); Marc Christenson, Round Rock, TX (US); Nathan Powelson, Round Rock, TX (US); Alex Avila, Round Rock, TX (US); Bryson Tanner, Round Rock, TX (US)

(73) Assignee: Sisu Devices LLC, Round Rock, TX (US)

(21) Appl. No.: 17/840,970

(22) Filed: Jun. 15, 2022

Related U.S. Application Data
(60) Provisional application No. 63/210,987, filed on Jun. 15, 2021.

(51) Int. Cl. B25J 9/16

(52) U.S. Cl. CPC B25J 9/1664; B25J 9/1653; B25J 9/1651; B25J 9/1697

(57) ABSTRACT

This disclosure describes systems, methods, and devices related to robot camera control. A robotic device may receive a user input to control a camera operatively connected to the robot device; identify a live-motion filter applied to the camera; identify a filter setpoint associated with the live-motion filter; generate filtered position control data for the camera based on the user input, the live-motion filter, and the filter setpoint; generate joint data for the robot device based on the filtered position control data; and cause the camera to move according to the joint data.

### CROSS-REFERENCE TO RELATED APPLICATION(S)

This application claims the benefit of U.S. Provisional Application No. 63/210,987, filed Jun. 15, 2021, the disclosure of which is incorporated by reference as set forth in full.

### TECHNICAL FIELD

This disclosure generally relates to systems, methods, and devices for robotic motion technologies and, more particularly, for robotic camera control.

### BACKGROUND

In general, robotic devices consist of multiple axes of motion, allowing robotic control of position and orientation in space. Multi-axis robotic devices are capable of moving within a given number of dimensions in space, allowing points in space to be captured and programmed, which allows a robotic device to move and behave in a certain way. For example, a robotic device having six degrees of freedom (DOF) is capable of a full range of orientations and positions within a given space.

### BRIEF DESCRIPTION OF THE DRAWINGS

FIG. 1 depicts a diagram illustrating an example network environment of an illustrative robotic drive control system, in accordance with one or more example embodiments of the present disclosure.

FIG. 2A depicts an illustrative schematic diagram of a robotic drive control system, in accordance with one or more example embodiments of the present disclosure.

FIG. 2B depicts an illustrative schematic diagram of a robotic drive control system, in accordance with one or more example embodiments of the present disclosure.

FIG. 3 depicts a robotic drive control system, in accordance with one or more example embodiments of the present disclosure.

FIG. 4 depicts a robotic drive control system, in accordance with one or more example embodiments of the present disclosure.

FIG. 5 depicts a schematic diagram of a control loop for a robotic camera control system, in accordance with one or more example embodiments of the present disclosure.

FIG. 6A depicts an illustrative target tracking process for a robotic camera, in accordance with one or more example embodiments of the present disclosure.

FIG. 6B depicts an illustrative geometry parameterization process for a robotic camera, in accordance with one or more example embodiments of the present disclosure.

FIG. 7A depicts an example circular arc for a robotic camera, in accordance with one or more example embodiments of the present disclosure.

FIG. 7B depicts an example circular orbit for a robotic camera, in accordance with one or more example embodiments of the present disclosure.

FIG. 7C depicts an example circular orbit for a robotic camera, in accordance with one or more example embodiments of the present disclosure.

FIG. 7D depicts an example circular orbit for a robotic camera, in accordance with one or more example embodiments of the present disclosure.

FIG. 8 depicts a schematic diagram of an orbit lock filter for a robotic camera control system, in accordance with one or more example embodiments of the present disclosure.

FIG. 9 depicts example robotic camera and target paths, in accordance with one or more example embodiments of the present disclosure.

FIG. 10A depicts an example blending of keyframes for linear moves for a robotic camera, in accordance with one or more example embodiments of the present disclosure.

FIG. 10B depicts an example blending of keyframes for moves for a robotic camera, in accordance with one or more example embodiments of the present disclosure.

FIG. 11 illustrates an example acceleration profile for a robotic camera, in accordance with one or more example embodiments of the present disclosure.

FIG. 12A depicts a flow diagram of an illustrative process for a robotic camera control system, in accordance with one or more example embodiments of the present disclosure.

FIG. 12B depicts a flow diagram of an illustrative process for a robotic camera control system, in accordance with one or more example embodiments of the present disclosure.

FIG. 13 depicts a block diagram of an example robotic machine upon which any of one or more techniques (e.g., methods) may be performed, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments set forth in the claims encompass all available equivalents of those claims.

Robots may be remotely controlled and may include one or more cameras whose motion may be remotely controlled. In cinematography, it is often desirable to have a target or object centered and in focus during a camera shot. Object tracking is currently performed with some cinematography robots by typically one of two methods: (1) Building up a digital 3D model of a filming set and objects to be filmed, and path planning by defining virtual paths around those digital models. While this method provides the ability to pre-visualize complex and smooth paths, it may be difficult to closely match the real-world filming set, and may be time-consuming. These downsides not only cost more time prior to filming, but often require last-minute on-set changes, resulting in whole production crew delays, and extra expense; (2) Manually defining many points along the robot path to ensure the camera vector stays aligned and in focus with an object. While defining many points may provide flexibility and may result in easier on-set last minute changes, the definition may require a significant amount of time and money, especially on-set. Changes to the path points while on-set often require people to stand around waiting for the new robot path to be programmed before filming can start again.

There is therefore a need for enhanced robotic camera control.

In one or more embodiments, a cinema robot may allow a user to define an object or target trajectory alongside the trajectory generated for robotic camera movement. The robot may generate and execute a trajectory for each of its joints as well as focus, zoom, and iris motors such that a physical or virtual object will always be centered and in focus throughout the programmed moves. The object can be either a real object being tracked or a virtual object whose movement corresponds to desired camera centering and focus. In this manner, the trajectory of the camera may be defined by a physical object or a point in space where the camera should remain focused even during robot movement.

In one or more embodiments, the object and camera trajectories may be defined by keyframes, which allow a user to indicate when in time they want the target and the camera to be at particular 3D locations in space. The camera's keyframe locations may be taught by the user moving the camera with a wand or other controller to the desired locations and saving the location to the keyframe. The target locations are taught by the user focusing the camera on a desired target and saving this to the target keyframe. When this happens, the robot determines the 3D position in space of the desired target using forward kinematics with the current joint values of the robot, for example, as well as the value of the focus motor and lens configuration (e.g., a mapping of focus motor values to a focal distance). Other methods that can be used to teach target location are distance sensors such as laser range finders, ultrasonic range finders, stereo vision cameras, time of flight cameras, etc. These types of sensors can be mounted near the camera to provide accurate distance measurements to the target. Camera and target keyframes may, but do not need to, occur at the same times. The trajectory between keyframes may be defined by multiple aspects: The type of path that the camera or target may take between the keyframes, the time that the camera or target will be at each point along the defined paths, and the definition of how camera roll is constrained. While the keyframes may be generated by user-live motion, they also may be generated offline.

In one or more embodiments, the target path and camera paths each may have separate options of how their paths are generated. These can be, but are not limited to, either linear, spline, circular, elliptical, or joint-only motion. Linear motion creates a path in a straight line between the two 3D locations of the keyframes. Spline motion creates a spline interpolation, such as cubic spline interpolation, between all subsequent spline motion keyframes. Joint-only motions will move the robot in the shortest distance in joint space between two keyframes. Circular and elliptical motion moves the path in a circular or elliptical motion between keyframes, respectively. Users are able to specify move types for both the camera and target between keyframes. Accordingly, the camera may move from the coordinate location of one keyframe to the coordinate location of another keyframe based on the type of movement specified by the user. Similarly, the target may move from the coordinate location of one keyframe to the coordinate location of another keyframe based on the type of movement specified by the user, and the movement of the target does not need to be the same type of movement as the movement of the camera.

In one or more embodiments, camera and target paths may be defined by the collection of various geometries including linear, splines, circular arcs, and ellipses. Keyframes may be defined at the end points of each of the geometries to specify the time at which the camera or target should be at the corresponding location. The 3D path between subsequent keyframes may be given a parameterization, or equation where an input of 0 may generate an output of the 3D coordinates of the first of the subsequent keyframes, and input of the total length of the path between keyframes may generate an output of the 3D coordinates of the of the second of the subsequent keyframes. With the path parameterization defined, the trajectory timeline along the defined path may be determined using a 1D trajectory generation algorithm. Additionally, multiple sections of the overall path can be combined into a piecewise parameterization to allow for a single 1D trajectory generation algorithm over combined geometry. This can allow for a single acceleration and deceleration value and constant velocity period over the combined geometry if a trapezoidal acceleration profile for the 1D trajectory generation is used.

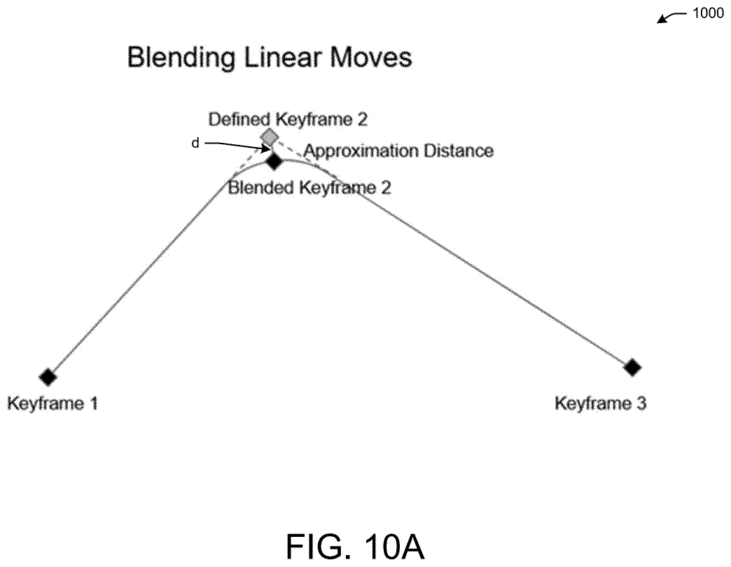

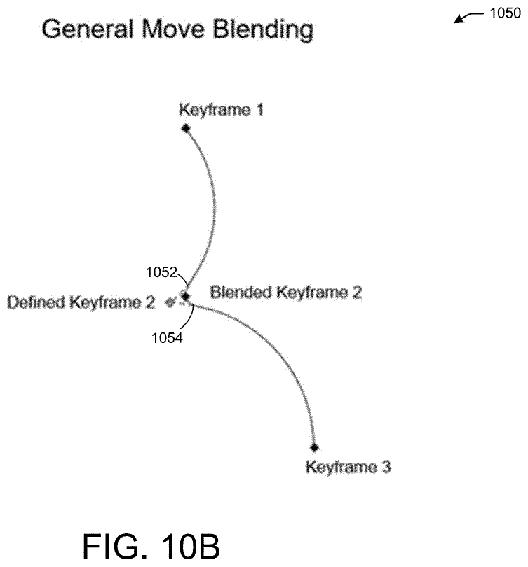

In one or more embodiments, a linear camera move may be blended into a subsequent linear move with an intermediate circular arc. The circular arc is defined by the tangents of the two linear moves and an approximation distance that determines the distance between the intersection of the two lines and the circular arc. The approximation distance may be defined by the user. The timing of move may execute so the camera reaches the point on the circular arc closest to the defined keyframe 2 (e.g., blended keyframe 2, as shown in FIG. 10A) at the time specified by the defined keyframe 2. Additionally, keyframe 2 may be removed so that the linear-to-linear blending becomes a piecewise parameterization allowing a constant velocity through the blending if a trapezoidal acceleration profile trajectory generation is used.

In one or more embodiments, any path geometry may be blended into a subsequent path geometry with an intermediate spline. The intermediate spline is defined by a start point located on the first path geometry, an end point located on the second path geometry, and the tangents at these two locations. The start and end points may be defined by the user. The timing of the move may execute so the camera reaches the halfway point of the intermediate spline at the time specified by the defined keyframe 2 (e.g., shown in FIG. 10A). Additionally, keyframe 2 may be removed so that the two geometries and their blending may become a piecewise parameterization. This may allow a constant velocity through the blending if a trapezoidal acceleration profile trajectory generation is used.

In one or more embodiments, to determine the time that the camera or target will be at each point along the path, the paths may be input into a trajectory generating algorithm. The 3D coordinates of a path from start to end of each path type may have a parameterization, or equation where an input of 0 may generate an output of the 3D coordinates of the keyframe at the beginning of the move, and an input of the total length of the move may generate an output of the 3D coordinates of the keyframe at the end of the move. With the path parameterization defined, the trajectory timeline along the defined path may be determined using a 1D trajectory generation algorithm. The algorithm may plan a trajectory and break that trajectory into time increments from 0 to the total length of the move in the desired time between keyframes. Boundary condition constraints also may be defined between keyframes, such as start and end velocities and or accelerations. Specifying non-zero start and end velocities is the way that continuous moves through keyframes may occur. This may be facilitated with a handshake of an agreed upon velocity between subsequent moves. When a joint-move is going into a Cartesian move, such as a linear or spline move, the robot's manipulator Jacobian may determine the mapping of a Cartesian velocity to the joint velocities. The same may be true for a Cartesian move going into a joint-move. A spline may be defined such that the beginning of the spline is tangent to another Cartesian move, such as a linear or circular move, preceding the spline to allow for continuous velocities through the keyframe. The same may be true so that the end of spline is tangent to another Cartesian move that follows the spline.

In one or more embodiments, each move segment starting and ending acceleration and jerk profiles may be adjustable. To simplify the user interface, the robot may prompt the user for the acceleration times, and automatically may determine the acceleration and jerk values by solving for the minimum jerk to maintain a trapezoidal acceleration profile. The trapezoidal profile provides the ability to have a constant velocity section of the trajectory, and it provides a simple way to enforce acceleration times. The minimum jerk solution provides a more natural motion with smooth trajectory segments across the range of acceptable acceleration values. Other 1D trajectory generation methods can be used. Other options used in unique situations include trajectory profile generation based on cubic or quintic functions for position and trapezoidal acceleration profiles with acceleration values instead of time being the input. Additionally, an alternate method may include taking multiple sections of the overall path, such as linear, spline, circular, robot joint-only, or elliptical sections, with their respective parameterizations, and defining them into a piecewise function, and thus combining move segments into a single equation that can be acted upon by input parameters such as starting and ending acceleration and jerk. This allows the ability to apply a single set of acceleration and deceleration times for combined moves, such as a linear move followed by a circular move. This is also how constant velocity can be maintained over move segments enabling linear-to-linear continuous moves, arc-to-linear, arc-to-arc, orbit-to-orbit, and other complex moves.

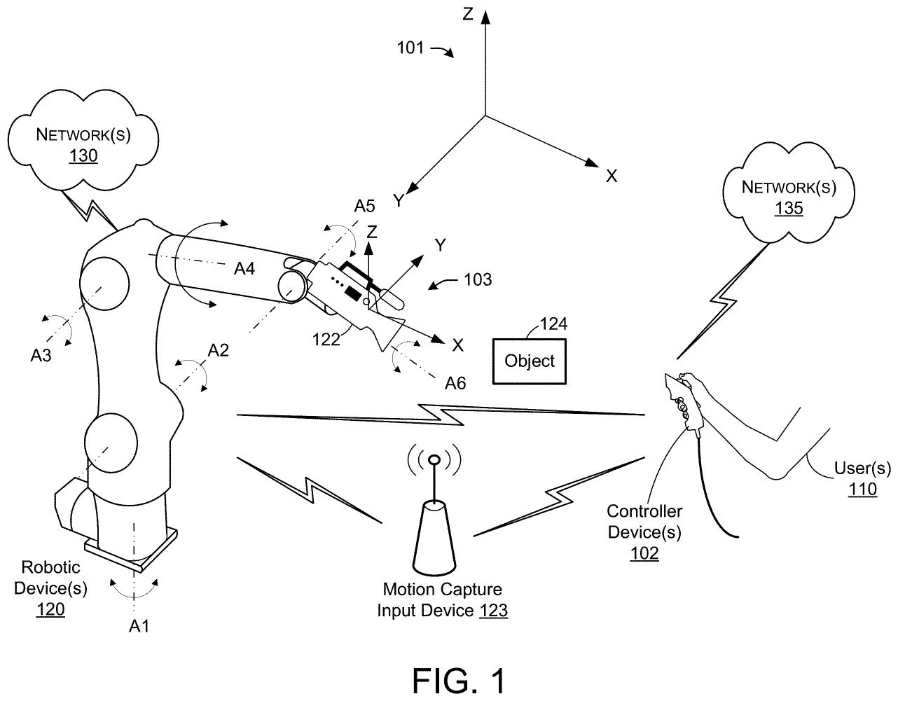

In one or more embodiments, the solution of calculating the camera position with respect to the global frame while generating the trajectory is not fully constrained until the roll of the camera is defined (see FIG. 1). There are multiple ways of incorporating roll constraints into the solution: (1) synchronized roll; (2) unsynchronized roll; and (3) horizon lock. Synchronized roll may refer to where change in roll for a move segment is set to match the change of the other orientations of the camera, pitch, and yaw, during the move. This is a typical method and generally used, but can cause undesired roll motion accelerations in between two move segments that have large differences in roll. Unsynchronized roll may refer to manually defining the acceleration and deceleration times for the camera roll axis for the move segment. This may be the defined as the same acceleration and deceleration times of the camera motion as a whole. This allows the operator to manually adjust the rate of roll to a desired value when transitioning between move segments. Horizon Lock may refer to where the roll is locked to the global frame horizon by fixing the angle between the axis perpendicular to the lens of the camera, extending out the camera's side (e.g., the y-axis of the robot tool frame represented by the coordinate system 103 as shown in FIG. 1) and the vertical axis (e.g., z-axis) of the robot global frame (e.g., the coordinate system 101 as shown in FIG. 1). In cinematography, camera operators often want their camera parallel to the horizon and to avoid any motion on the roll axis while continuing to yaw (pan) and pitch (tilt). Horizon lock is further expanded to include trajectory generation solutions with user-generated live motion. In user-generated live motion, where the robot path is on-the-fly generated by user interaction with sensors or pressing buttons, the path often is unknown beforehand and is not pre-planned. To prevent camera roll from happening in live motion, a control loop may be implemented to monitor and minimize the change of angle between the y-axis of the robot tool frame (the camera) and the z-axis of the robot global frame (robot base). This control loop may minimize the change in angle by adjusting the on-the-fly robot tool pose. This allows users to set the robot in a mode where the camera does not roll while moving with live motion. The horizon lock technology can be further used to lock other motion besides the horizon, allowing for the fixing of an angle between one of the tool axes in reference to one of the global axes during on-the-fly live motion.

While moving a robot with live on-the-fly motion, which may be facilitated by using sensors to mimic human motion, there are often parts of the motion being mimicked that are undesirable. For example, if a cinema camera is the device being moved by the robot, often the user wants to keep the camera horizontal and not induce any motion in the roll axis of the camera. By enabling the Horizon Lock Motion Filter, any user input motion that is being mimicked in live motion may be filtered out and ignored. The user may be able to have the robot mimic the user's live hand motion while ignoring any motion that would cause movement in the camera (tool frame) roll axis. In this manner, some user movements may correspond to an allowed motion implemented by the robot or camera and a filtered out motion not implemented (e.g., a camera rotation filtered out due to the Horizon Lock Motion Filter).

In one or more embodiments, a user may select either the tool frame or the base frame, or may define other relative frames to use when defining live-motion filters. An axis lock (e.g., as shown in FIG. 1) may limit live motion along an axis relative to the tool frame or the base frame (e.g., where the Z-axis is vertical). The locked axis may be any of the X, Y, or Z axes. The axis may be defined as the closest axis from where the live motion starts. Based on the position of a camera, the camera rotation may be locked about an axis corresponding to the camera's position at the time when the lock is enabled. The frame may be defined by a user input to select either the tool frame or the base frame. Any live-motion filter may allow a user to limit and control desired robot motion when live-motion mimics user motion or responds to user inputs (e.g., button pushes, touches, etc.). For example, if an axis lock is applied to a camera for a particular axis, movement of a remote controller device that, without the axis lock applied, would result in a rotation of the camera not about the axis would not result in the corresponding rotation when the axis lock is applied. Users may select modes allowing both rotation and translation of the robot and/or camera, rotation without translation, or translation without rotation. In this manner, some inputs to cause translation or motion may be allowed, and others may be filtered out to prevent corresponding motion or translation in response to user inputs. A user may select whether the robot tool only rotates (e.g., roll, pitch, yaw motions, etc.) or only translates (e.g., X, Y, Z), or both, with input from live motion.

In one or more embodiments, users may select modes corresponding to the speed at which the robot and/or camera may translate or rotate in response to a movement of the remote control (or a button/joystick of a remote control). For example, a slow-motion mode may cause the robot and/or camera to translate or rotate at a slower rate than the corresponding user input, and a fast motion mode may cause the robot and/or camera to translate or rotate at faster rate than the corresponding user input. The users may be able to update the speeds at which the slow-motion moves from anywhere between zero to the maximum possible speed for the particular type of movement.

In one or more embodiments, a user may define the geometry of an object path, and a robotic camera path. The user may generate trajectories along these paths such that for a given time between a start time, t=0, and a final time, t=t_{f}, the position of the object and/or camera is known. At a given time, t=tᵢ, the robot may determine its orientation by ensuring that the Camera Frame is aligned so the axis of camera lens (the x-axis of FIG. 1) goes from the camera's position t=tᵢ to the object's position and t=tᵢ. This ensures that the object is in the center of the frame. The y and z axes are aligned such that the camera satisfies a roll constraint. The robotic camera may generate the necessary joint configuration to achieve this position and orientation through an inverse kinematics algorithm. The robotic camera may generate and execute a trajectory for each of its joints to ensure that the object is in the center of the frame for all times between t=0 and t=t_{f}. At a given time, t=tᵢ, the robot may determine the focus distance required to keep the object in focus by calculating the distance, d, between the object and camera positions at t=tᵢ. The robot may use a mapping of focal distance to motor encoder positions to determine a trajectory for a focus motor, such that the object remains in focus for all times between t=0 and t=t_{f}.

In one or more embodiments, a sphere lock filter may be enabled to ensure that the robot tool center point (TCP) and/or camera moves along the surface of a defined sphere. By enabling the sphere lock filter, any user input motion that would cause motion off of the sphere is filtered out and ignored. The user may be able to have the robot mimic their live hand motion while ignoring any motion that could cause the TCP to not move along the surface of the sphere. The sphere may be defined by the camera's location when the sphere lock is enabled and a center point defined by the user. The center point 3D position may be determined by using forward kinematics of the joint values and the value of the focus motor and lens configuration when the sphere lock is enabled.

In one or more embodiments, the execution of point-by-point path planning to get to a desired position on the sphere from a current position on a sphere for sphere lock may use a trajectory planning on individual spherical coordinates.

In one or more embodiments, to ensure the TCP and/or camera stays on the sphere throughout all motion from a current position to a desired position on the sphere while using sphere lock, an execution of a point-by-point path planning using spherical coordinates may be used. The coordinates for the radial distance, polar angle, and azimuth angle may be r, θ, and φ respectively. When a new desired position on the sphere is received from the sphere filter, a new local spherical coordinate system may be defined where the zero positions for θ and φ are at the current position of the TCP and/or camera and the arc between the current position and desired position are only along the θ direction. A plan along the surface of the sphere may be planned in the θ and φ coordinates with r being held constant to ensure motion does not exit the surface of the sphere. Initial conditions may be set for the trajectory plan of θ and φ by converting any current motion of the TCP and/or camera represented in Cartesian XYZ coordinates to the locally defined spherical coordinates. The plan for φ may be executed to arrive at zero as soon as possible in order to quickly round corners to account for changes in direction of the movement along the surface of the sphere. The velocity, acceleration, and jerk limits for the trajectories of θ and φ may be determined by dividing Cartesian limits for velocity, acceleration, and jerk limits by the radius of the sphere, r. The planned trajectories for θ and φ may be executed by sampling them at each robot control timestep and then converting the output values of θ and φ and known r (radius of the sphere) to the global Cartesian coordinate system of the robot. These Cartesian coordinates may be put into an inverse kinematics algorithm to determine the joint values at which to command the robot to execute the trajectory.

In one or more embodiments, a target lock filter may be enabled to ensure that the camera keeps a target position in the center of view. By enabling a target lock filter, any user input motion that would cause camera motion to not keep a target in the center of view is filtered out and ignored. The user may be able to have the robot mimic their live hand motion while ignoring any motion that would cause the target to not be in the center of view of the camera. The 3D position of the target may be determined by using forward kinematics of the joint values and the value of the focus motor and lens configuration when the target lock is enabled. The target lock filter causes the trajectories of the camera's yaw and pitch to be completely determined by its position in 3D space as these are constrained at any given 3D location in order to have the target be in the center of view. This may require the filter to apply a rotation to the camera in order to keep the target in view if only a translational input was given by the user. The camera's roll trajectory may be generated independently to apply any desired roll from user input.

In one or more embodiments, when a new desired position is given by the target lock filter, a trajectory may be generated to achieve the desired end pose. The translation trajectory and roll trajectories may be planned independently. The yaw and pitch trajectories must be reliant on the output of the translation trajectory in order to ensure target tracking. The roll trajectory may be determined by finding a delta roll to be applied from the current pose to the desired pose. This delta roll may be found by finding the shortest intermediate rotation that would cause the lens axis of the current pose match the lens axis of the desired pose. The desired delta roll may then be determined from the angle about the camera lens axis that is needed to go from this intermediate frame to the desired pose. A trajectory for roll may be formed from this delta rotation and any initial velocities and accelerations on roll from any previous command.

In one or more embodiments, the target lock trajectory may be executed by sampling the translation and roll trajectories at each robot control timestep. The yaw and pitch are determined at each control step by ensuring the lens axis of the camera points to the target. An intermediate frame may be made that enforces that the lens axis is aligned to the target, but without changing any roll from the current orientation at the time step. The roll trajectory may then be applied to this intermediate orientation by finding the difference in roll between the current and previous timestep and then applying this to the intermediate orientation frame to get the desired orientation for the current timestep.

In one or more embodiments, an orbit lock filter may be enabled to ensure that the robot TCP and/or camera moves along the surface of a defined sphere and keeps the center of sphere in the center of the field of view of the camera. This may be done by combining the sphere lock and target lock filters mentioned in other embodiments.

The present disclosure combines the flexibility of defining manual points on-set (or in another setting or context) along with a fast programmable user interface including tools to track objects, define complex and smooth motion paths, and minimize manual keyframes. All of this saves significant time compared to existing solutions while still allowing for the complex shot that a film director or other user may want.

The above descriptions are for purposes of illustration and are not meant to be limiting. Numerous other examples, configurations, processes, etc., may exist, some of which are described in detail below. Example embodiments will now be described with reference to the accompanying figures.

FIG. 1 is a diagram illustrating an example network environment of an illustrative robotic drive control device system, in accordance with one or more example embodiments of the present disclosure. The network environment 100 may include robotic device(s) 120 and one or more controller devices 102, which may communicate in accordance with, and be compliant with, various communication standards and protocols, such as Wi-Fi, user datagram protocol (UDP), time-sensitive network (TSN), wireless USB, Wi-Fi peer-to-peer (P2P), Bluetooth, near field communication (NFC), or any other communication standard.

In some embodiments, the robotic device 120 may include or otherwise be operatively connected to an image capture device 122 (e.g., a camera, connected via an end effector, gripper, etc.). Movement of the robotic device 120 may cause movement of the image capture device 122 (e.g., about a global frame represented by the coordinate system 101 and about a tool frame represented by a coordinate system 103 relative to the TCP of the robotic device 120), and the image capture device 122 may rotate about one or more axes. The image capture device 122 may move using an object trajectory alongside the trajectory generated for robotic camera movement. The robotic device 120 may generate and execute a trajectory for each of its joints as well as focus, zoom, and iris motors such that an object (e.g., object 124) will always be centered and in focus throughout the programmed moves.

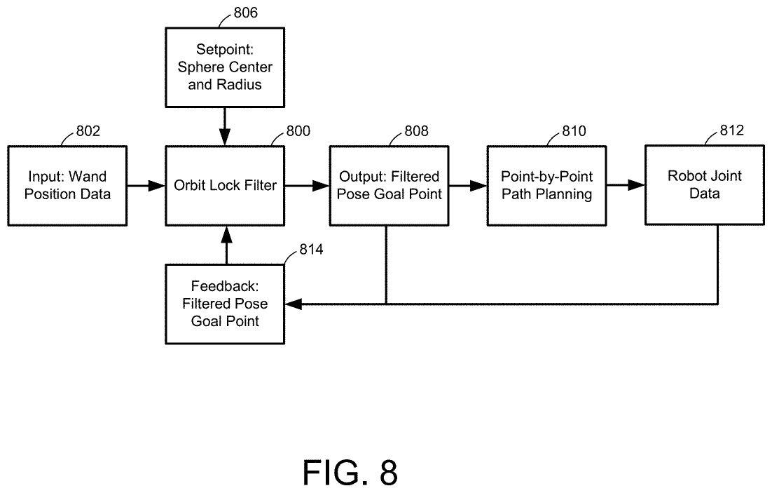

In some embodiments, the robotic device 120, a motion capture input device 123, and a controller device 102 may include one or more computer systems similar to that of the example machine/system of FIG. 8.

In one embodiment, and with reference to FIG. 1, a robotic device 120 may communicate directly with the controller device 102. For example, the two devices may communicate through a wired or a wireless connection. In other examples, the two devices may communicate through a motion capture input device 123, where the motion capture input device 123 may act as a base station. In some scenarios, the robotic device 120 and the controller device 102 may communicate through various networks (e.g., network 130 and/or 135).

The robotic device 120 may have various applications. For example, the robotic device 120 may be configured as an industrial robot, an aerospace application, an automation tool, welding, painting, or any other applications.

The controller device 102 may be a handheld device, such as a joystick, which may be used as a form of motion input. The vector of joystick motion may be mapped to a plane intersecting the controller device 102, and corresponding global position vectors are applied to the robotic device 120.

The controller device 102 may control the robotic device 120 by transmitting control signals to the robotic device 120 through a wire or through wireless signals and vice versa. For example, the controller device 102 may send the control signal as an Ethernet packet through an Ethernet connection to the robotic device 120.

The motion capture input device 123 may be a stand-alone device or may be included in the robotic device 120. The controller device 102 may communicate the position and orientation data of the control device 102 to the motion capture input device 123. This maps the local orientation and position data into a coordinate system aligned with the robot's motion control system. The motion control system of the robot may consist of multiple axes of motion, controlled through a Cartesian coordinate system through an inverse kinematics mapping in one embodiment, or with each axis of motion-controlled directly with no transformation mapping in another embodiment. Motion data from the controller device is transmitted to the motion system associated with the robot through a robot communication interface. This interface can be any wired or wireless communication protocol used to send and receive motion information from the robot. In one embodiment, the robot communication protocol may be a UDP message sent from the robot to the motion capture input device 123, with an expected reply containing the next required position to move to.

The controller device 102 and the robotic device 120 may communicate using a robot communication protocol such as a user datagram protocol (UDP). A UDP message may be sent from the robotic device 120 to the controller device 102 or vice versa. A reply to the UDP message may contain a next position or a new position that the robotic device 120 will move to.

The robotic device 120 may receive the control signal and may be controlled by the received control signal. The control signal may be received directly from the controller device 102, or maybe received through the motion capture input device 123. For example, the control signal may cause the robotic device 120 to apply or remove pneumatic air from a robotic gripper of the robotic device 120. Further, the control signal may cause the robotic device 120 to move to a new position in space. When the robotic device 120 receives the control signal, new state information is applied, and any needed motion to the new position may be executed. The robotic device 120 may also transmit a signal indicating its status to the controller device 102, which may happen directly between the controller device 102 and the robotic device 120 or through the motion capture input device 123.

The robotic device 120 may be configured to rotate along axes of motions (e.g. rotary joints) or translate along axes of motion (e.g. prismatic joints such as a linear track). The robotic device 120 consisting of these rotation or translation axes of motion may allow control of the position and orientation in space. For example, the robotic device 120 may have six or more degrees of freedom resulting in a full range of orientations and positions within a given space. Programming the positions of these axes may be done manually, by assigning angular or linear values to each axis and building a sequence of points to accomplish a given task. Programming can also be accomplished by mapping the axes to a coordinate system (e.g., coordinate system 101), allowing the inverse kinematics of the motion system to control the axes. This is useful particularly for robotic arms and provides for a Cartesian coordinate system to be used in place of a difficult to navigate robotic configuration space coordinate system. In this manner, the robot may receive Cartesian programs and use its own controller to plan its movements with respect to individual axes, or the robot may have its joint axes programmed manually.

In the example of FIG. 1, the robotic device 120 may be configured to have six rotation axes, A1, A2, A3, A4, A5, and A6. Each of the rotation axes A1, A2, A3, A4, A5, and A6 is able to allow a section of the robotic device associated with that axis to rotate around that axis. When all of the angles of the rotation axes A1, A2, A3, A4, A5, and A6 are determined, the entire status of the robotic device 120 may be determined.

In one embodiment, the controller device 102 and the robotic device 120 may utilize a synchronized coordinate system (e.g., coordinate system 101) that facilitates mapping all of the rotation axes A1, A2, A3, A4, A5, and A6 to the coordinate system 101. Moving the controller device 102 along at least one of the axes of the coordinate system 101 may control the angles of the rotation axes A1, A2, A3, A4, A5, and A6 of the robotic device 120 according to the position, orientation, and movement of the controller device 102. That is, a user 110 may be able to manipulate the position, orientation, and movement of the controller device 102 and, as a result, manipulating the position, orientation, and movement of the robotic device 120. The position, orientation, and movement of the controller device 102 may be translated into instructions that may be used in one or more control signals to control the robotic device 120. Ultimately, these instructions may control the angles of the rotation axes A1, A2, A3, A4, A5, and A6, in order to perform a certain action or to move the robotic device 120 to a new position in space.

In one embodiment, object and camera trajectories may be defined by keyframes (e.g., video intra-frames), which allow the user 110 to indicate when in time they want the target and the image capture device 122 to be at particular 3D locations in space. The image capture device's keyframe locations may be taught by the user 110 moving the image capture device 122 with the controller device 102 to the desired locations and saving the location to the keyframe. The target locations are taught by the user focusing the image capture device 122 on a desired target (e.g., the object 124) and saving this to the target keyframe. When this happens, the robotic device 120 determines the 3D position in space of the desired target using forward kinematics with the current joint values of the robot as well as the value of the focus motor and lens configuration (e.g., a mapping of focus motor values to a focal distance). The trajectory between keyframes may be defined by multiple aspects: The type of path that the image capture device 122 or target may take between the keyframes, the time that the image capture device 122 or target will be at each point along the defined paths, and the definition of how image capture device 122 roll is constrained.

In one embodiment, some movements of the controller device 102 may be filtered to avoid corresponding movement of the robotic device 120 and/or the image capture device 122. While moving the robotic device 120 with live on-the-fly motion, which may be done by using sensors to mimic human motion, there are often parts of the motion being mimicked that are undesirable. For example, if a cinema camera is the image capture device 122 being moved by the robotic device 120, the user 110 may want to keep the image capture device 122 horizontal and not induce any motion in the roll axis of the image capture device 122. By enabling the Horizon Lock Motion Filter, any user input motion that is being mimicked in live motion is filtered out and ignored. The user 110 may be able to have the robot mimic their live hand motion while ignoring any motion that would cause movement in the image capture device 122 (tool frame) roll axis.

In one or more embodiments, the robotic device 120 may be a six degree of freedom industrial robotic arm. The robotic device 120 may also be a six degree of freedom industrial robotic arm mounted on a linear track making a seven degree of freedom system.

While FIG. 1 shows the robotic device 120 with the image capture device 122, the robotic device 120 may be used for other contexts without a camera, such as welding (e.g., coordinating robotic welding tip with a moving work-holding mechanism), or other applications in which the robotic device 120 may perform operations and/or control other devices operatively connected to the robotic device 120.

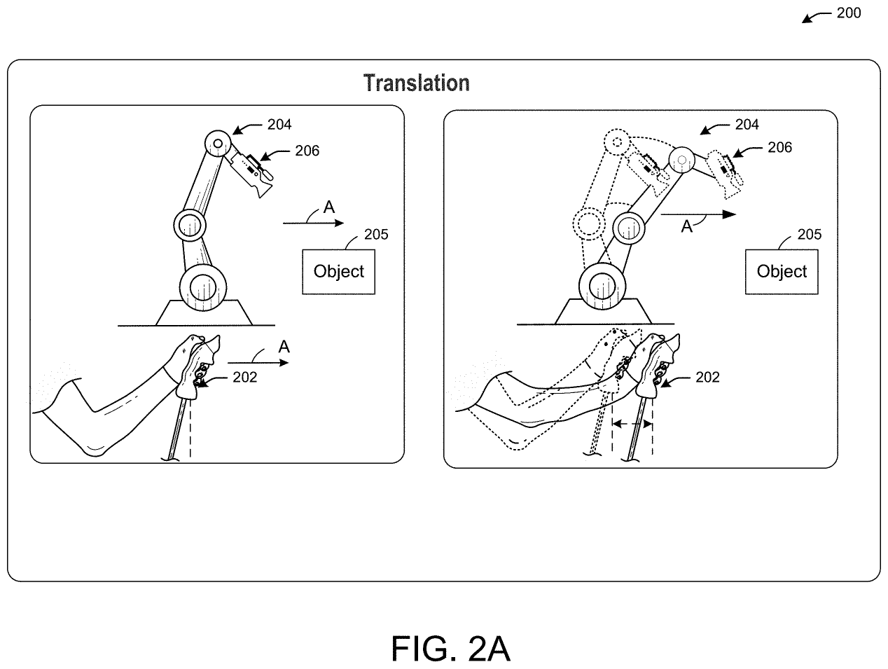

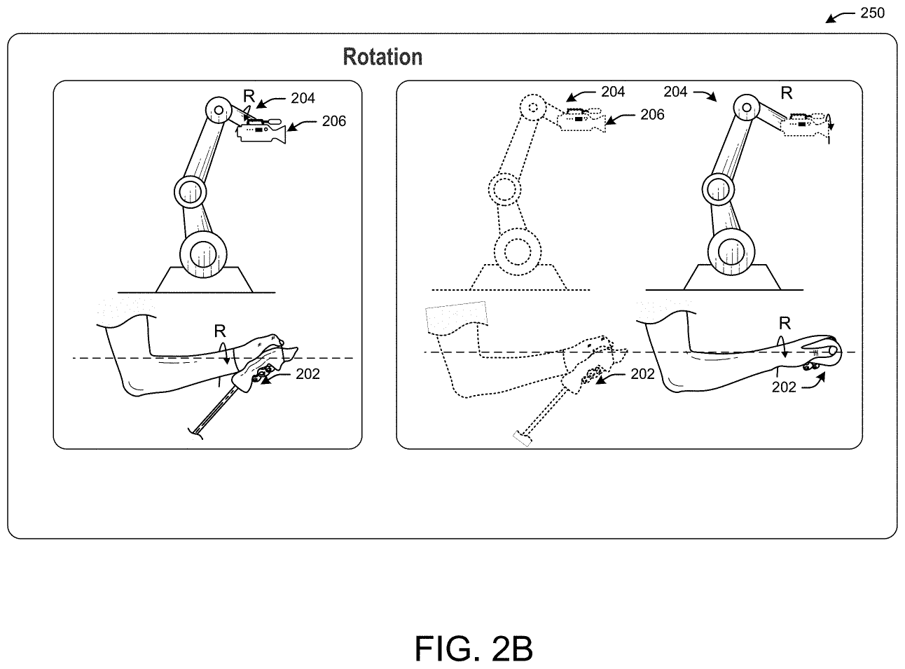

FIG. 2A depicts an illustrative schematic diagram of a robotic drive control system 200, in accordance with one or more example embodiments of the present disclosure.

FIG. 2B depicts an illustrative schematic diagram of a robotic drive control system 250, in accordance with one or more example embodiments of the present disclosure.

Referring to FIGS. 2A-2B, there is shown a handheld component 202 (e.g., the controller device 102 of FIG. 1). The handheld component 202 associated with a “Drive” feature is a small device that consists primarily of—but is not limited to—a controller containing a small joystick and a trigger.

“Drive” is intuitive in that the way that the controller is moved and handled will directly translate to the way that the end effector moves and handles itself, thus creating a relatively simple way to program robots (e.g., robot 204). Put simply, the way that the user moves the controller is the way that the end effector of the robot 204 moves.

Robot Movements—Translation (FIG. 2A):

Translation refers to the change in position of the robot's tool center point (TCP) (this is separate from changes in the TCP frame orientation). To get the TCP to translate in Drive the user simply pulls the trigger of the handheld component 202 and moves the controller of the handheld component 202. The TCP will start moving in the direction that the user moved relative to where the user's hand was when the trigger was first pulled. One can imagine that, when the user pulls the trigger and moves the controller, a vector is generated in the direction of motion relative to the controller home. The robot 204 TCP will move in the direction defined by that vector. The speed at which the robot 204 TCP moves may be determined by a speed filter. However, the robot 204 may not move at a top speed if there is a small motion of the controller. How much the trigger is pressed may affect the goal point, which may affect speed. If the trigger is fully pressed, the goal position may match the user's motion (e.g., one-to-one). If the trigger is only pressed halfway, then the robot 204 may follow half of the user's input for the goal.

Translation movements may be part of a preset path. In one or more embodiments, the robot 204 shown may allow a user to define an object trajectory alongside the trajectory generated for robotic camera movement. The robot 204 may generate and execute a trajectory for each of its joints as well as focus, zoom, and iris motors such that the object 205 will always be centered and in focus (e.g., from the perspective of a camera 206 controlled by the robot 204) throughout the programmed moves. The object 205 and camera 206 trajectories may be defined by keyframes, which allow a user to indicate when in time the target and the camera are to be at particular 3D locations in space. The camera's keyframe locations may be taught by the user moving the camera 206 with a wand or other controller (e.g., of the handheld component 202) to the desired locations and saving the location to the keyframe. The target locations are taught by the user focusing the camera 206 on a desired target and saving the desired target location to the target keyframe. When this happens, the robot 204 determines the 3D position in space of the desired target using forward kinematics with the current joint values of the robot 204 as well as the value of the focus motor and lens configuration (e.g., a mapping of focus motor values to a focal distance). Other methods that can be used to teach target location are distance sensors such as laser range finders, ultrasonic range finders, stereo vision cameras, time of flight cameras, etc. These types of sensors can be mounted near the camera to provide accurate distance measurements to the target. The trajectory between keyframes may be defined by multiple aspects: The type of path that the camera 206 or target may take between the keyframes, the time that the camera or target will be at each point along the defined paths, and the definition of how camera roll is constrained.

The user may define an object trajectory and the trajectory for robotic camera movement. The robot 204 may generate and execute a trajectory for each of its joints as well as focus, zoom, and iris motors such that the object 205 will always be centered and in focus with regard to the camera 206 throughout the programmed moves.

Robot Movements—Rotation (FIG. 2B):

Rotation refers to the change in orientation of the robot 204 TCP (this is separate from changes in the TCP translation). To get the robot 204 TCP to rotate in Drive the user simply pulls the trigger and rotates the controller (e.g., of the handheld component 202). When this occurs the robot 204 TCP will rotate around an axis parallel to the axis that defines the rotation from home to the current location of the controller, and the robot 204 TCP will continue to rotate around an axis that is parallel to the controller axis of rotation (even as the controller changes orientation) until the user stops the movement by letting up on the trigger or moves the controller back into the no move buffer zone. The speed at which the robot 204 TCP rotates may be determined by a speed filter. However, the robot 204 may not move at a top speed if there is a small motion of the controller. How much the trigger is pressed may affect the goal point, which may affect speed. If the trigger is fully pressed, the goal position may match the user's motion (e.g., one-to-one). If the trigger is only pressed halfway, then the robot 204 may follow half of the user's input for the goal

While moving the robot 204 with live on-the-fly motion, which may be facilitated by using sensors to mimic human motion, there are often parts of the motion being mimicked that are undesirable. For example, if a cinema camera is the device being moved by the robot 204, often the user wants to keep the camera 206 horizontal and not induce any motion in the roll axis of the camera 206. By enabling the Horizon Lock Motion Filter, any user input motion that is being mimicked in live motion is filtered out and ignored. The user may be able to have the robot 204 mimic their live hand motion while ignoring any motion that would cause movement in the camera 206 (tool frame) roll axis.

In one or more embodiments, a user may select either the tool frame or the base frame, or may define other relative frames to use when defining live-motion filters. An axis lock may limit live motion along an axis relative to the tool frame or the base frame (e.g., where the Z-axis is vertical). The locked axis may be any of the X, Y, or Z axes. The axis may be defined as the closest axis from where the live motion starts. Based on the position of the camera 206, the camera 206 rotation may be locked about an axis corresponding to the camera's position at the time when the lock is enabled. The frame may be defined by a user input to select either the tool frame or the base frame. A user may select whether the tool frame only rotates (e.g., roll, pitch, yaw motions, etc.) or only translates (e.g., X, Y, Z), or both, with input from live motion. Any live-motion filter may allow a user to limit and control desired robot motion when live-motion mimics user motion or responds to user inputs (e.g., button pushes, touches, etc.). For example, if an axis lock is applied to the camera 206 for a particular axis, movement of a remote controller device (e.g., the handheld component 202) that, without the axis lock applied, would result in a rotation of the camera 206 about the axis would not result in the corresponding rotation about the axis when the axis lock is applied.

Referring to FIGS. 2A and 2B, in one or more embodiments, users may select modes corresponding the speed at which the robot 204 and/or camera 206 may translate or rotate in response to a movement of the remote control (or a button/joystick of the handheld component 202). For example, a slow-motion mode may cause the robot 204 and/or camera 206 to translate or rotate at a slower rate than the corresponding user input, and a fast motion mode may cause the robot 204 and/or camera 206 to translate or rotate at faster slower rate than the corresponding user input. In one or more embodiments, users may select modes allowing both rotation and translation of the robot 204 and/or camera 206, rotation without translation, or translation without rotation. In this manner, some inputs to cause translation or motion may be allowed, and others may be filtered out to prevent corresponding motion or translation in response to user inputs.

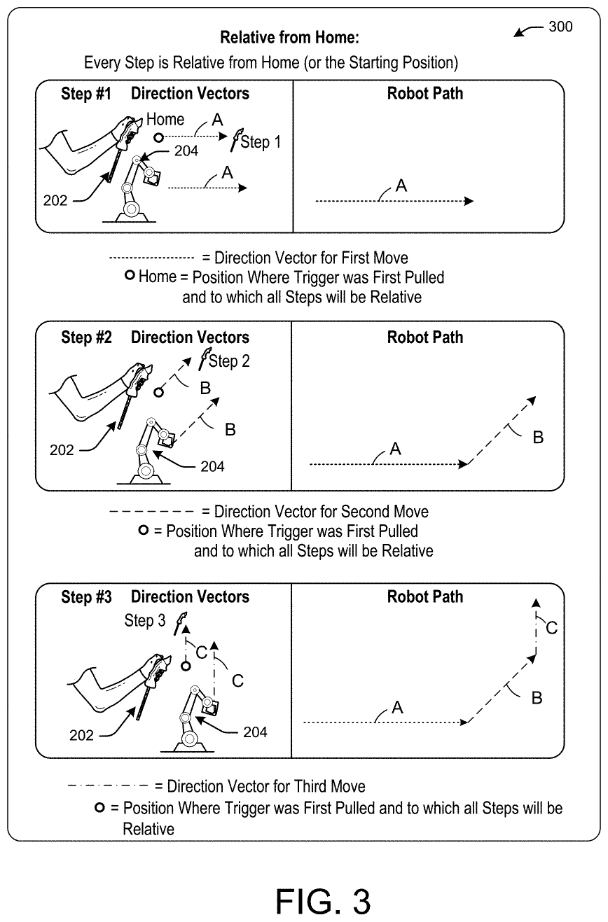

FIG. 3 depicts a robotic drive control system 300, in accordance with one or more example embodiments of the present disclosure.

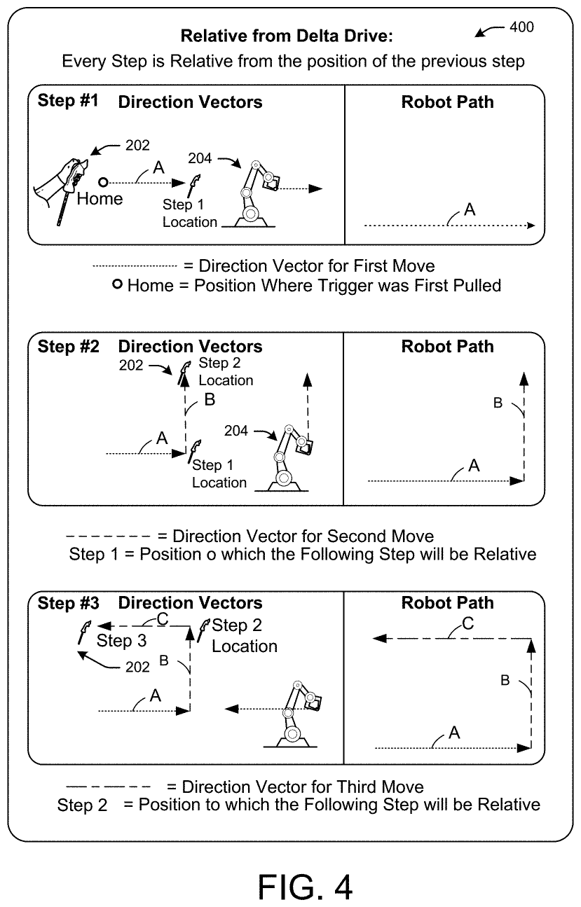

FIG. 4 depicts a robotic drive control system 400, in accordance with one or more example embodiments of the present disclosure.

In one or more embodiments, a Drive software (e.g., when the robot continues moving in a direction as long as the trigger is pulled) will come equipped with several different functions that can—but do not have to be—selected in order to change or alter the way that the robot TCP moves relative to the controller.

In one or more embodiments, a robotic drive control system may facilitate one or more Controller Motion Functions. Some of these functions include, but are not limited to:

1. Plane Lock: If the user turns on Plane Lock they will be able to lock the robot 204 motion (when the trigger of the handheld component 202 is pulled) so that the tool frame is constrained to a plane that is perpendicular to a specified TCP axis (wherever that TCP frame is located when Plane Lock is turned on). When the trigger is pulled in Plane Lock mode the robot 204 TCP can translate only in the plane that is perpendicular to the specified TCP axis and it can only rotate about the axis perpendicular to that plane.

2. Snap to Axis: If the user turns on snap to axis the robot's movements will automatically snap to the axes of a specified frame (e.g., tool, base, robot global) that the controller motion (e.g., motion of the handheld component 202) is most aligned with.

3. Translation Lock (e.g., rotation mode): If the user turns on the translation lock the robot TCP will no longer be able to translate, though it will retain its ability to rotate.

4. Rotation Lock (e.g., translate only): If the user turns on the rotation lock the robot 204 TCP will no longer be able to rotate, though it will retain its ability to translate.

5. Tool frame, Global frame, and Base frame: When snap to axis is enabled, the specified reference frame determines which axis the motion is constrained or snapped to. In tool frame all movements are relative to the axis directions of the tool frame. In global frame all movements are relative to the axis directions of the global robot frame. In base frame all movements are relative to the axis directions of the user-defined base frame. Note that global frame is a fixed reference frames (as the global frame does not move), while the tool frame is a relative reference frame (as it is relative to the fixed frames). A user-defined base may be either fixed or moving (e.g., the base may be defined on the tool link or any other link of the robot). It is important to note that when rotation occurs the center of rotation is always the robot TCP. If the user switches from tool reference to global/base reference the rotating about an axis will occur at the robot TCP around the global/base axis that is parallel to the controller rather than the axis that is referenced by the tool frame.

Joystick Drive Variation:

A slight deviation from the above stated Drive mode would be Joystick Drive mode. In Joystick Drive mode the joystick would act solely as a device to produce translation (while the trigger would retain the ability to produce both translation and rotation movements). In Joystick Drive the direction of motion is dictated by the direction the joystick is pushed, including the orientation of the controller itself. The robot 204 TCP will move in whatever direction the joystick is pointed. One embodiment includes a configuration so that a joystick drive produces translations that snap to the xy, yz, or xz planes of the current frame.

Joystick Rotation Drive Variation:

A slight deviation from the above stated Joystick Drive would be Joystick Rotation Drive. In Joystick Rotation Drive the robot 204 would be able to rotate around whatever axis the joystick (e.g., the handheld component 202) is currently at (there would be no snapping to predefined axes involved, thus allowing the user to rotate around any desired point/axis). As the robot 204 is rotating around the chosen axis and the user decides to move and/or rotate to a new axis the robot 204 will fluidly follow and will also begin rotating around the new axis. In Joystick Rotation Drive the center of rotation is the robot 204 TCP. One embodiment includes a configuration so that a joystick drive produces rotations that snap to the x, y, or z axes of the current frame.

Joystick Rotation Drive will also have a feature that enables the user to move one joint of the robot 204 at a time using the controller trigger or the controller joystick. This will be accomplished by the user aligning the controller with the desired axis, selecting that axis, then twisting the controller or using the joystick until the axis has been moved to the new position. The user may be able to move a single prismatic joint a time (such as a track) by aligning the controller with the axis joint, selecting the axis, and pushing the joystick in the desired direction.

Uses for Drive:

Drive—as being used in association with various robots—could be used (but would not be limited to) the following applications: large robot motions, painting, teleoperation robotics, part detection and manipulation, material removal, etc. It is understood that the above descriptions are for purposes of illustration and are not meant to be limiting.

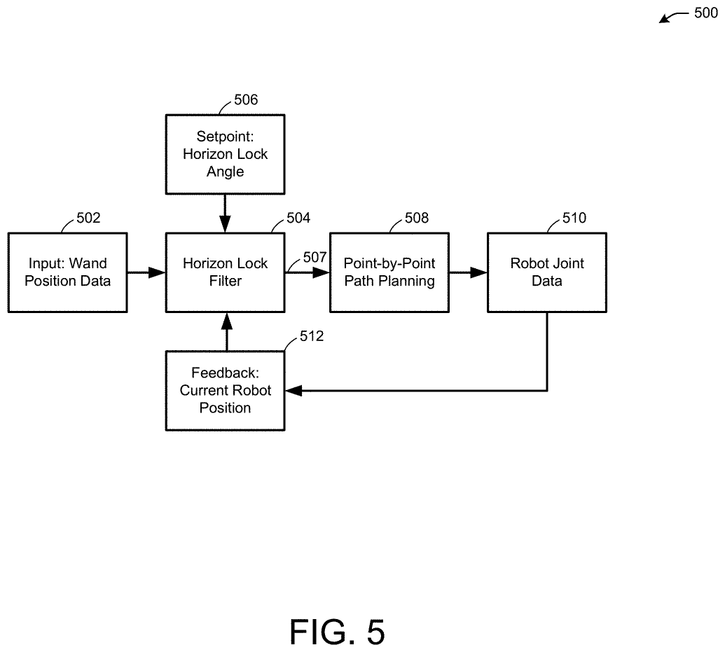

FIG. 5 depicts a schematic diagram of a control loop 500 for a robotic camera control system, in accordance with one or more example embodiments of the present disclosure.

Referring to FIG. 5, the control loop 500 may include the receipt of an input 502 (e.g., wand position data based on a movement, touch, etc., of the one or more controller devices 102 of FIG. 1 or the handheld component 202 of FIG. 2A). When a horizon lock filter 504 is enabled, a horizon lock angle may be used as a setpoint 506 to determine how to move the robot and/or camera (e.g., FIG. 1, FIGS. 2A-4). The output of the horizon lock filter 504, based on the wand position data input 502 and the setpoint 506, may be filtered position control data 507. The horizon lock filter 504 may limit live motion along an axis relative to the tool frame or the base frame (e.g., where the Z-axis is vertical) of the robot and/or camera. The locked axis may be any of the X, Y, or Z axes. Based on the position of a camera, the camera rotation may be locked about an axis corresponding to the camera's position at the time when the lock is enabled.

Still referring to FIG. 5, using point-by-point path planning 508, robot joint data 510 may be generated to determine the movements and position of the robot to cause the robot to move to particular points on a path. As the robot moves corresponding to commands based on the robot joint data, the current robot position at any time may serve as feedback 512 to the horizon lock filter 504, allowing for adjustment of the filtered position control data and point-by-point path planning 508 in response to subsequent wand position data as inputs.

The horizon lock technology can be further used to lock other motion besides the horizon, allowing for the fixing of an angle between one of the tool axes in reference to one of the global axes during on-the-fly live motion.

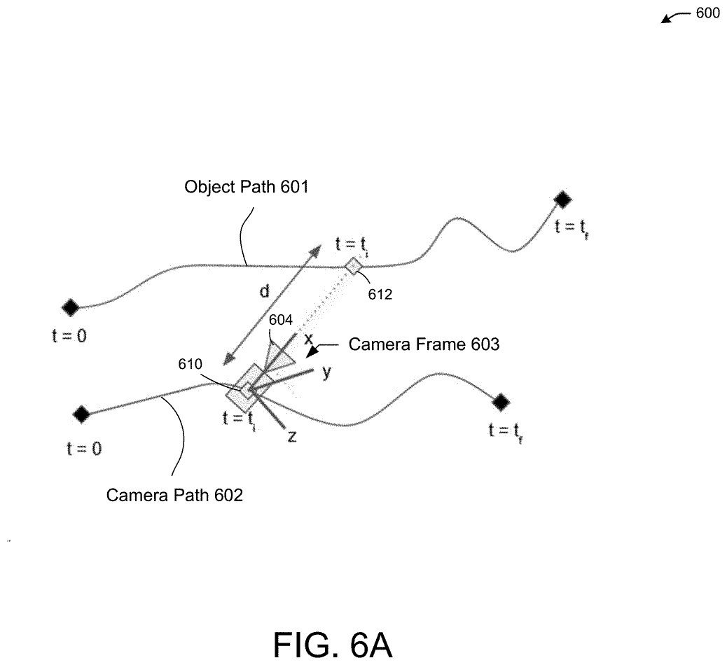

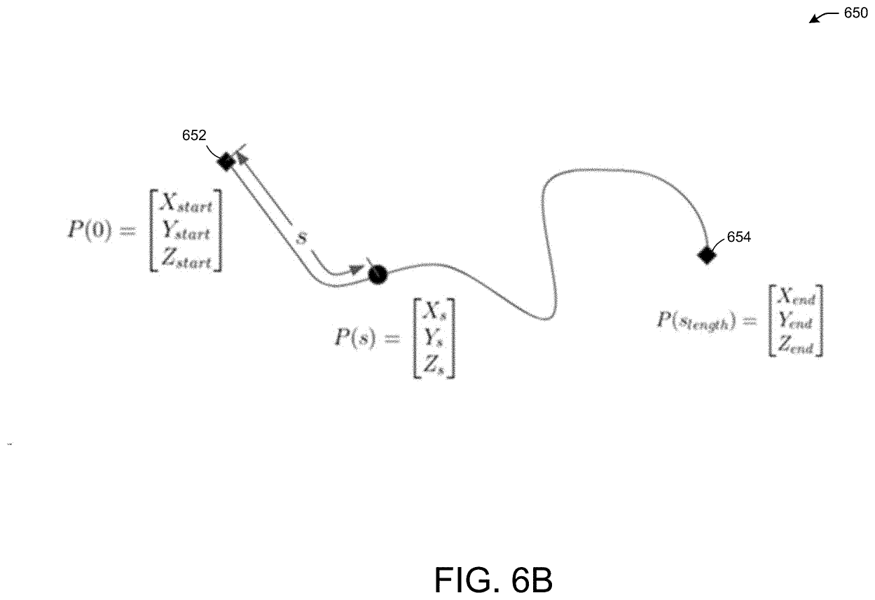

FIG. 6A depicts an illustrative target tracking process 600 for a robotic camera, in accordance with one or more example embodiments of the present disclosure.

Referring to FIG. 6A, a user may define the geometry of an object path 601 (e.g., a path of the object 124 of FIG. 1 or the object 205 of FIG. 2A), and a robotic camera path 602 (e.g., a path of the robotic device 120 of FIG. 1 or of the robot 204 of FIG. 2A). The user may generate trajectories along these paths such that for a given time between a start time, t=0, and a final time, t=t_{f}, the position of the object and/or camera is known. At a given time, t=tᵢ, the robot may determine its orientation by ensuring that a camera frame 603 is aligned so the axis of camera lens 604 (the x-axis) goes from the camera's position at t=tᵢ (e.g., at keyframe 610) to the object's position and t=tᵢ (e.g., at keyframe 612). This ensures that the object is in the center of the frame. The y and z axes are aligned such that the camera satisfies a roll constraint. The robotic camera may generate the necessary joint configuration to achieve this position and orientation through an inverse kinematics algorithm. The robotic camera may generate and execute a trajectory for each of its joints to ensure that the object is in the center of the frame for all times between t=0 and t=t_{f}. At a given time, t=tᵢ, the robot may determine the focus distance required to keep the object in focus by calculating the distance, d, between the object and camera positions at t=tᵢ. The robot may use a mapping of focal distance to motor encoder positions to determine a trajectory for a focus motor, such that the object remains in focus for all times between t=0 and t=t_{f}.

FIG. 6B depicts an illustrative geometry parameterization process 650 for a robotic camera, in accordance with one or more example embodiments of the present disclosure.

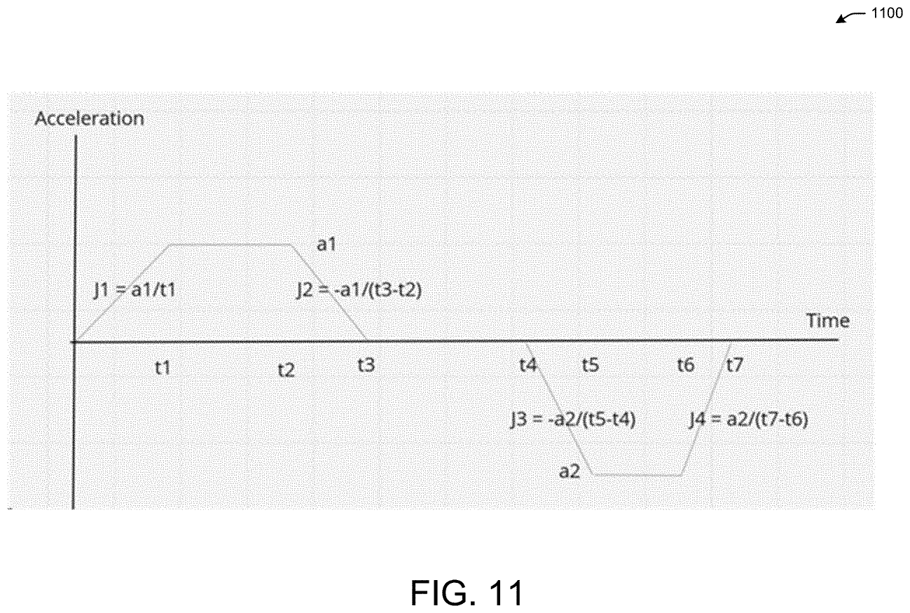

The 3D coordinates of a path from start to end of each path type may have a parameterization, or equation, P(s), where s is the distance along the path's curve from the path's start. An input of 0 may generate an output of the 3D coordinates of the keyframe 652 at the beginning of the move, and an input of the total length of the move, s_{length}, may generate an output of the 3D coordinates of the keyframe 654 at the end of the move. With this formulation, a 1D trajectory generation on s may be performed. In the cases of the camera and target trajectories, the change in rate of s over time resulting from the 1D trajectory generation represents the velocity the camera or target will take in 3D space. Boundary conditions, such as start and end velocities and/or accelerations, may be enforced on the trajectory generation of s. Specifying non-zero start and end velocities is the way that continuous moves through keyframes may occur. This may be facilitated with a handshake of an agreed upon velocity between subsequent moves. In this manner, to facilitate continuous moves from keyframe to keyframe, the start and end velocities may be greater than zero, and to transition the robot from keyframe to keyframe with non-zero velocities, the acceleration of the robot may decrease (e.g., as shown in FIG. 11) as the robot approaches a keyframe, and may increase as the robot transitions away from a keyframe and toward a next keyframe. Therefore, the trajectory may be set based on the start and end velocities and based on the acceleration profile.

The parameterization P(s) for a linear move may be described as: P(s)=Pi+s/s_{length}(Pf−Pi), where Pi is the 3D location of the start of the line, Pf is the 3D location of the end of the line, s_{length} is the length of the line (e.g., the distance between Pf and Pi), and s is the input parameter as described above. With this parameterization, the 3D location of any point along the line that is s distance from Pi may be determined.

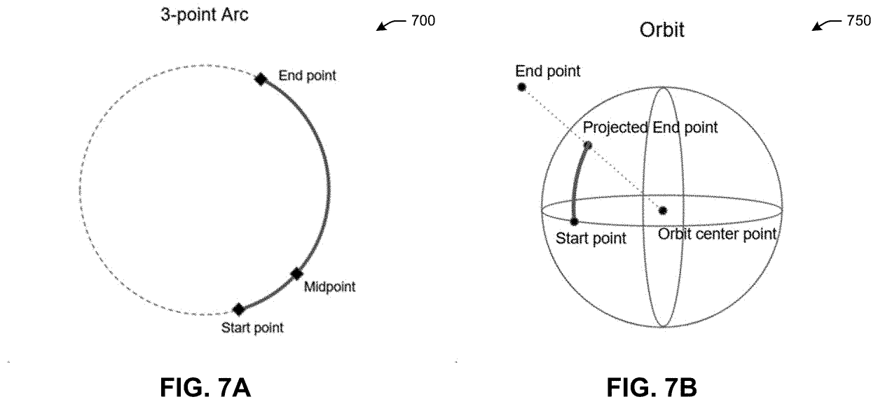

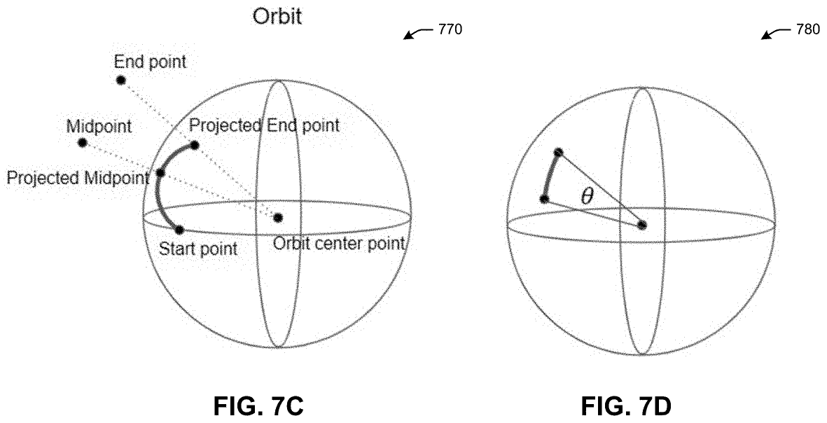

FIG. 7A depicts an example circular arc 700 for a robotic camera, in accordance with one or more example embodiments of the present disclosure.

FIG. 7B depicts an example circular orbit 750 for a robotic camera, in accordance with one or more example embodiments of the present disclosure.

FIG. 7C depicts an example circular orbit 770 for a robotic camera, in accordance with one or more example embodiments of the present disclosure.

FIG. 7D depicts an example circular orbit 780 for a robotic camera, in accordance with one or more example embodiments of the present disclosure.

Referring to FIGS. 7A-7D, circular motions may be defined as the geometry of a camera or target path (e.g., the object path 601 and the camera path 602 of FIG. 6A) in multiple ways including three-point arcs (FIG. 7A) and orbits (FIGS. 7B and 7C). Three-point arcs may be defined from three distinct Cartesian locations defined by the user: a start point, a midpoint, and an end point as shown in FIG. 7A, for example. From these three distinct locations, a circular arc may be formed that starts at the start point, goes through the midpoint, and finishes at the end point. The camera locations may be taught by the user moving the camera with a wand or other controller (e.g., the controller device 102 of FIG. 1, the handheld component 202 of FIG. 2A) to the desired locations and saving the location. The target locations may be taught by the user focusing the camera on a desired target and saving this location. Orbits may be defined by three distinct, non-colinear points defined by the user: a start point, an orbit or sphere center point, and an end point (e.g., as shown in FIG. 7B). From these points a circular arc may be formed along the surface of a sphere whose center is the sphere center point and has the start point on the sphere's surface. The circular arc starts at the start point and ends at the projection of the end point onto the sphere. The start and end points may be taught by the user moving the camera with a wand or other controller to the desired locations and saving the locations. The orbit or sphere center point may be taught by the user focusing the camera on a desired center point and saving this location. Orbits may alternatively be defined by a fourth distinct point called the midpoint (e.g., as shown in FIG. 7C). A circular arc may be formed along the surface of a sphere whose center is the sphere center point and has the start point on the sphere's surface. The circular arc starts at the start point and goes through the projection of the midpoint onto the sphere and ends at the projection of the end point onto the sphere. This may allow for circular arcs along the sphere that are not constrained to be great circles along the sphere. The midpoint may be taught by the user moving the camera with a wand or other controller to the desired location and saving the location.

Referring to FIGS. 7A-7D, a parameterization of a circular arc may be represented by:

$$\vec{p} ( s ) = \vec{c} + R {\vec{p}}^{′} ( s ) , {\vec{p}}^{′} ( s ) = [ \begin{matrix}p cos ( \frac{s}{p} ) \\ p sin ( \frac{s}{p} ) \\ 0\end{matrix} ] ,$$

where c is the center of the circle in 3D space, p is the radius of the circle, and s is a given arc length along the curve at which a position is desired. R is the rotation matrix that transitions from a local frame of reference at the center of the arc to the global frame, and is defined as:

$$R = [ \frac{\vec{x}}{‖ \vec{x} ‖} \frac{\vec{z} \times \vec{x}}{‖ \vec{z} \times \vec{x} ‖} \frac{\vec{z}}{‖ \vec{z} ‖} ] ,$$

where vector z is the normal axis (e.g., a vector extending out of the plane of the circle) and x is a vector extending from the center of the circle to the starting position of the arc.

FIG. 8 depicts a schematic diagram of an orbit lock filter 800 for a robotic camera control system, in accordance with one or more example embodiments of the present disclosure.

Referring to FIG. 8, the orbit lock filter 800 may include the receipt of an input 802 (e.g., wand position data based on a movement, touch, etc., of the one or more controller devices 102 of FIG. 1 or the handheld component 202 of FIG. 2A). When the orbit lock filter 800 is enabled, a sphere center and radius may be used as a setpoint 806 to determine how to move the robot and/or camera (e.g., FIG. 1, FIGS. 2A-4). The output of the orbit lock filter 800, based on the wand position data input 802 and the setpoint 806, may be filtered pose goal point data 808.

Still referring to FIG. 8, using point-by-point path planning 810, robot joint data 812 may be generated to determine the movements and position of the robot to cause the robot to move to particular points on a path. As the robot moves corresponding to commands based on the robot joint data, the current robot position at any time may serve as feedback 814 to the orbit lock filter 800, allowing for adjustment of the filtered pose goal point data 808 and point-by-point path planning 810 in response to subsequent wand position data as inputs.

The orbit lock filter 800 may be enabled to ensure that the robot TCP and/or camera moves along the surface of a defined sphere and keeps the center of sphere in the center of the field of view of the camera. This may be done by combining the sphere lock and target lock filters mentioned in other embodiments.

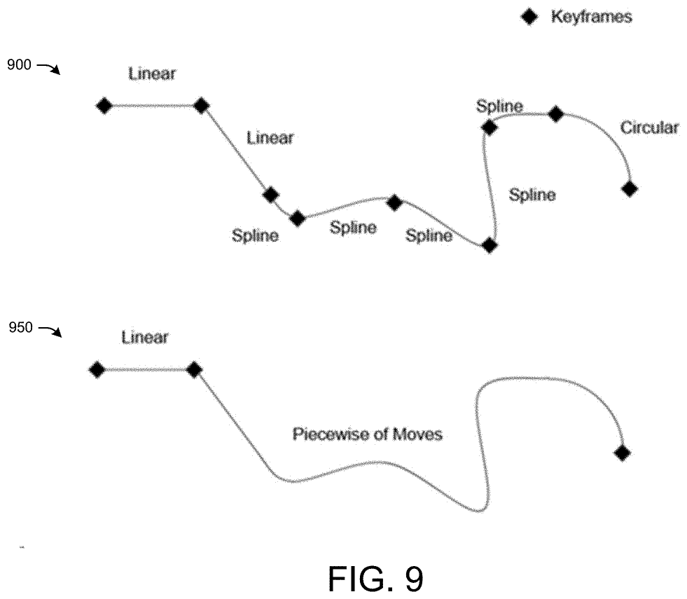

FIG. 9 depicts example robotic camera and target paths, in accordance with one or more example embodiments of the present disclosure.

Referring to FIG. 9, a path 900 and a path 950 are shown, and may include linear, spline, circular, and other piecewise moves. Camera and target paths may be defined by the collection of various geometries including linear, splines, circular arcs, and ellipses as shown in FIG. 9. Keyframes may be defined at the end points of each of the geometries to specify the time at which the camera or target should be at the corresponding location. The 3D path between subsequent keyframes may be given a parameterization, or equation where an input of zero may generate an output of the 3D coordinates of the first of the subsequent keyframes, and input of the total length of the path between keyframes may generate an output of the 3D coordinates of the of the second of the subsequent keyframes. With the path parameterization defined, the trajectory timeline along the defined path may be determined using a 1D trajectory generation algorithm. Additionally, multiple sections of the overall path can be combined into a piecewise parameterization to allow for a single 1D trajectory generation algorithm over combined geometry. This can allow for a single acceleration and deceleration value and constant velocity period over the combined geometry if a trapezoidal acceleration profile for the 1D trajectory generation is used.

A cubic spline path may be defined between subsequent keyframes. The geometry of the path may be defined by the following parameterization: x(t)=A+Bt+Ct²+Dt³, y(t)=E+Ft+Gt²+Ht³,z(t)=I+Jt+Kt²+Lt³, where 0≤t≤1, and the coefficients A-L may be determined through boundary conditions of the spline. For example, the boundary conditions may be: 1. The starting 3D point of the spline, P₁=[x₁ y₁ z₁]; 2. The ending 3D point of the spline, P₂=[x₂ y₂ z₂]; 3. The starting 3D tangent of the spline, t₁=[tₓ₁ t_{y1} t_{z1}]; and 4. The ending 3D tangent of the spline, t₂=[tₓ₂ t_{y2} t_{z2}]. The coefficients for x(t), y(t), and z(t) may be found separately based on the inputs. The coefficients of x(t), A, B, C, and D may be found by setting and solving the following linear system to satisfy the boundary conditions above:

$$[ \begin{matrix}1 & 1 & 1 & 1 \\ 1 & 0 & 0 & 0 \\ 0 & 1 & 2 & 3 \\ 0 & 1 & 0 & 0\end{matrix} ] [ \begin{matrix}A \\ B \\ C \\ D\end{matrix} ] = [ \begin{matrix}{x}_{2} \\ {x}_{1} \\ {t}_{x 2} \\ {t}_{x 1}\end{matrix} ] .$$

The coefficients E-L may be found using a similar linear system by replacing y and z with x.

To achieve the desired parameterization P(s) below that parameterizes the spline by arc length, a mapping may be made between the parameter t and s, called t(s):

$$P ( s ) = [ \begin{matrix}{X}_{s} \\ {Y}_{s} \\ {Z}_{s}\end{matrix} ] ,$$

which may result in the following parameterization:

$$P ( s ) = [ \begin{matrix}x ( s ) \\ y ( s ) \\ z ( s )\end{matrix} ] = [ \begin{matrix}A + Bt ( s ) + C {t ( s )}^{2} + D {t ( s )}^{3} \\ E + Ft ( s ) + G {t ( s )}^{2} + H {t ( s )}^{3} \\ I + Jt ( s ) + {Kt ( s )}^{2} + {Lt ( s )}^{3} +\end{matrix} ] .$$

The mapping t(s) may be found by evaluating the arc length s for given values of t between 0 and 1 using the following equation for arc length:

$$s ( t ) = {\int }_{{t}_{i}}^{{t}_{f}} \sqrt{{( \frac{d}{dt} X ( t ) )}^{2} + {( \frac{d}{dt} Y ( t ) )}^{2} + {( \frac{d}{dt} Z ( t ) )}^{2}} dt .$$

Alternatively, the mapping may be found by solving for t given values of s between 0 and the arc-length of the spline (determined by the equation above with t being equal to 1). This method may involve using an optimization method to determine the value of t that minimizes the error between its calculated arc-length from the equation above and the input arc length for which it is determining the t value. With matching values between t and s, various curve fitting or interpolation techniques may be used to achieve a mapping from any given s to a value of t. The cubic Hermit interpolation may be an interpolation technique that is utilized. The mapping may be enforced to not give any values of t greater than 1 or less than 0 to ensure the parameterization does not go outside of the desired spline path geometry.

To create a single trajectory over a combined complex trajectory, a piecewise parametrization may be utilized. This piecewise parameterization may combine the individual parametrizations of the path geometries that compose it. It may be of the form:

$$P ( s ) = ( \begin{matrix}{X}_{s} \\ {Y}_{s} \\ {Z}_{s}\end{matrix} ) ,$$

where P(0) may result in the position at the start of the complex geometry and P(s_{length}) may result in the position at the end of the complex geometry. The arc length of the complex geometry, si_{engt}h, may be found by adding all the arc lengths of the geometries that make up the complex geometry. Evaluating P(s) may involve finding which individual sub-geometry a given arc length, s, would reside on and calling the sub-geometry's parameterization. The input of this sub-geometry's parameterization may be the desired arc-length, s, of the complex geometry subtracted by the sum of the arc-lengths of all sub-geometries proceeding the sub-geometry on which s resides.

FIG. 10A depicts an example blending 1000 of keyframes for linear moves for a robotic camera, in accordance with one or more example embodiments of the present disclosure.

As shown in FIG. 10A, a linear move (e.g., between keyframes) may be blended into a subsequent linear move with an intermediate circular arc as seen in FIG. 10A. The circular arc (e.g., shown at blended keyframe 2) is defined by the tangents (e.g., the dashed lines) of the two linear moves and an approximation distance that determines the distance d between the intersection of the two lines and the circular arc. The approximation distance may be defined by the user. The timing of move may execute so the camera reaches the point on the circular arc closest to the defined keyframe 2 (blended keyframe 2) at the time specified by the defined keyframe 2. Additionally, keyframe 2 may be removed so that the linear-to-linear blending becomes a piecewise parameterization allowing a constant velocity through the blending if a trapezoidal acceleration profile trajectory generation is used.

FIG. 10B depicts an example blending 1050 of keyframes for moves for a robotic camera, in accordance with one or more example embodiments of the present disclosure.

As shown in FIG. 10B, a path geometry may be blended into a subsequent path geometry with an intermediate spline as seen in FIG. 10B. The intermediate spline is defined by a start point 1052 located on the first path geometry, an end point 1054 located on the second path geometry, and the tangents at these two locations. The start and end points may be defined by the user. The timing of the move may execute so the camera reaches the halfway point of the intermediate spline at the time specified by the Defined Keyframe 2. Additionally, keyframe 2 may be removed so that the two geometries and their blending may become a piecewise parameterization. This may allow a constant velocity through the blending if a trapezoidal acceleration profile trajectory generation is used.

FIG. 11 illustrates an example acceleration profile 1100 for a robotic camera, in accordance with one or more example embodiments of the present disclosure.

Referring to FIG. 11, acceleration of a robot is shown over time. With a trapezoidal profile, there may be eight unknowns (e.g., as long as the acceleration and deceleration times are both non-zero): t1, t2, t3, t4, t5, t6 (e.g., times 1-6), a1, and a2 (e.g., acceleration 1 and acceleration 2). Time t7 is not an unknown since it is the duration of the move in this example, but other examples may be used in the same fashion with different number of unknowns. When the acceleration and deceleration times (e.g., t_a1 and t_a2, respectively) are inputs from the user, the times t3 and t4 can be determined as: t3=t_a1, t4=t7−t_a2. This leaves six unknowns to solve for: t1, t2, t5, t6, a1, and a2. There may be two hard constraints with the end position and velocity: 1. Position constraint to go a desired delta position, Sf: where S_{f}=−⅓a₂t₇²+⅙a₂t₆²−⅓a₂t₇t₆+½a₂t₇t₅+½a₂t₇t₄−⅙a₂t₅²−⅙a₂t₅t₄−⅙ a₂t₄²+½a₁t₃t₇+½a₁t₂t₇−½a₁t₁t₇+v₀t₇−⅙a₁t₃²−⅙a₁t₃t₂−⅙a₁t₂²+⅙a₁t₁²+s₀; and 2. Velocity constraint to end a determined velocity Vf: where V_{f}=−½a₂t₇−½a₂t₆+½a₂t₅+½a₂t₄+½a₁t₃+½a₁t₂−½a₁t₁+v₀.

Two other constraints may be added and may require that the jerk values to be of equal magnitude during the acceleration and deceleration phases: J1=−J2, J3=−J4, which results in the following relationships: t1=t3−t2, t7−t6=t5−t4. Therefore, two more constraints may be needed to have a fully constrained system. There may be two paths forward: 1. Solve by first trying to find the minimum jerk solution. This solution adds the constraints of t1=t2, t5=t6. This solution is fully constrained, and rearranging the equations for Sf, Vf, J1, and J3 produces results for a1 and a2: a1=(2*(vf−v0)+a2*t_a2)/t_a1, a2=(sf−s0−vf*t7+0.5*vf*t_a1−0.5*v0*t_a1)/(−0.25*t_a2**2−0.25*t_a1*t_a2+0.5*t_a2*t7). However, this solution may result in accelerations outside of a maximum acceleration. If this is the case, instead of doing the minimum jerk constraints, another constraint may need to be applied, leading to a second option: 2. Solve by setting values for a1 and a2, which may be set based off of option 1. If a1 and a2 were out of bounds, they may be set to the bound, if one was in the bound, it may be set to the value calculated in option 1. Then there are only the four unknowns: t1, t2, t5, and t6. Rearranging the system of equations of the position, velocity, and Jerk magnitude constraints results in: t5=(sf−s0+0.5*(vf−v0)*t_a1−vf*t7+a2*(0.5*t7*t_a2−t7**2+0.5*t7*t_a1))/(a2*(0.5*t_a2+0.5*t_a1−t7)) and t1=a2/a1*(t5−t7)+t_a1+(v0−vf)/a1, and t2 and t4 can then be backed out from the Jerk constraints reproduced from above: t2=t3−t1, t6=t7−t5+t4.

In another embodiment, the acceleration profile 1100 as a trapezoidal acceleration trajectory profile may be generated using desired acceleration values input by a user. There may be six unknowns: t1, t2, t3, t4, t5, and t6. To constrain the equation, the solution that results in minimum Jerk may add the following constraints: t1=t2, t5=t6. Two more constraints may be added by requiring the Jerks to be equal in magnitude: J1=−J2 and J3=−J4. Knowing that: J1=a1/t1, J2=−a1/(t3−t2), J3=−a2/(t5−t4), J4=a2/(t7−t6), the following relationships may be determined from the equal magnitude of jerk constraints: t1=t3/2, t5=(t4+t7)/2. There also may be two hard constraints to ensure we reach the desired end velocity and position: 1. Velocity constraint to end a determined velocity Vf: V_{f}=−½a₂t₇−½a₂t₆+½a₂t₅+½a₂t₄+½a₁t₃+½a₁t₂−½a₁t₁+v₀; 2. Position constraint to go a desired delta position, Sf: S_{f}=−⅓a₂t₇²+⅙a₂t₆²−⅓a₂t₇t₆+½a₂t₇t₅+½a₂t₇t₄−⅙a₂t₅²−⅙a₂t₅t₄−⅙ a₂t₄²+½a₁t₃t₇+½a₁t₂t₇−½a₁t₁t₇+v₀t₇−⅙a₁t₃²−⅙a₁t₃t₂−⅙a₁t₂²+⅙a₁t₁²+s₀. This results in a system of six equations with the six unknown time values, which can be solved analytically by doing the following: Solve for t1, t2, t5, and t6 in terms of t2 and t4 which results in: t1=t2=t3/2, t5=t6=(t4+t7)/2. Substitute these equations for the time values into the Vf and Sf equations and rearrange the Vf equation to find t3 in terms of t4 which results in: t3=1.0/a1*(2*(vf−v0)+a2*t7−a2*t4). Plug this equation for t3 into the Sf equation and simplify. This ends up being a quadratic with respect to t4: A*t4\hat{ }2+B*t4+C=0, where A, B, and C are as defined as: A=−0.25*a2*(1+a2/a1), B=a2/a1*(vf−v0+0.5*a2*t7), C=0.25*a2*t7**2+vf*t7−(vf−v0)\hat{ }2/a1−(vf−v0)*a2*t7/a1−0.25*a2\hat{ }2*t7\hat{ }2/a1+s0−sf. Then solve for the roots of the quadratic which allows for determining t4. Then solve for t3 from t4. There are two solutions, including one where t4>=t3. Then solve for the rest of the times from t3 and t4 as reproduced from above: t1=t2=t3/2, t5=t6=(t4+t7)/2. There is a special case when a1=0 as the equation for B above would be undefined. In this scenario the end velocity constraint: V_{f}=−½a₂t₇−½a₂t₆+½a₂t₅+½a₂t₄+½a₁t₃+½a₁t₂−½a₁t₁+v₀ simplifies to: V_{f}=−½a₂t₇−½a₂t₆+½a₂t₅+½a₂t₄+v₀. Substituting the values reproduced by equations t5=t6=(t4+t7) from above into the Vf equation, it simplifies to: t4=t7+2*(vf−v0)/a2. The trajectory is only possible if t4 is greater than 0 and less than t7 in this case. The case where both a2 and a1 are 0, there is a trivial solution where the trajectory is constant velocity that needs to be verified to determine whether it satisfies the end velocity and position constraints to see if it is valid.

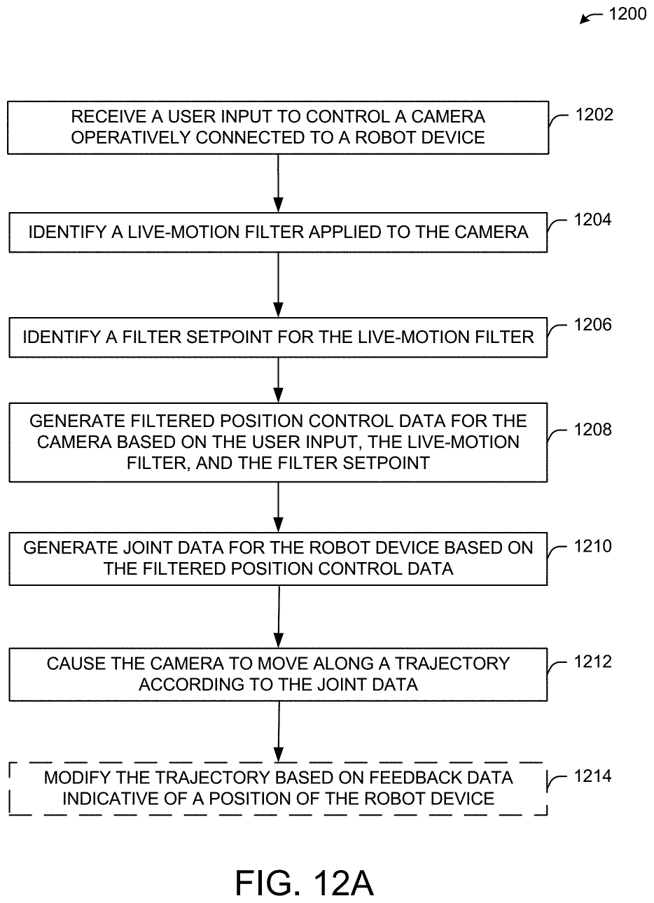

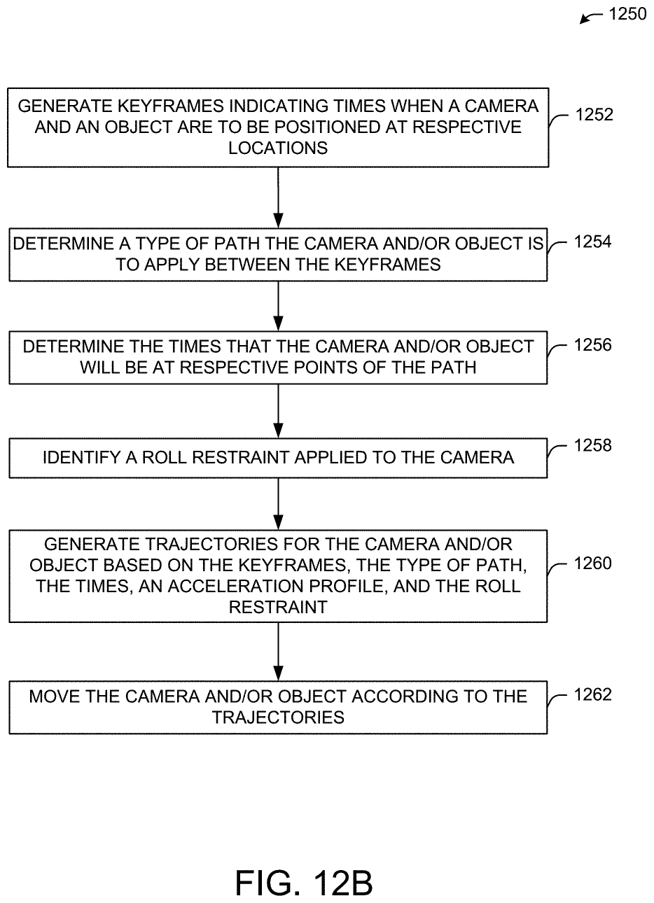

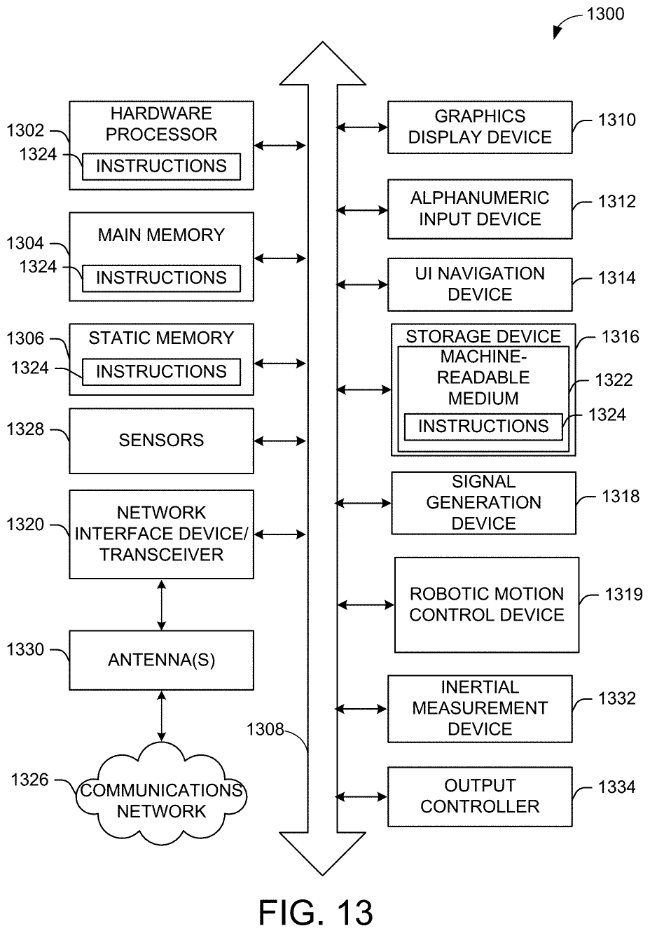

FIG. 12A illustrates a flow diagram of illustrative process 1200 for an illustrative robotic drive control system, in accordance with one or more example embodiments of the present disclosure.

At block 1202, a device (e.g., the robotic device(s) 120 of FIG. 1) may receive a user input to control a camera (e.g., the device 122 of FIG. 1) operatively connected to a robot device (e.g., the robotic device 120 of FIG. 1). The input may include a movement, such as a push, pull, roll, or click of a controller device (e.g., the controller device 102 of FIG. 1). The input may correspond to movement of the robotic device and/or the camera.

At block 1204, the device may identify a live-motion filter applied to the camera. The live-motion filter may be a live motion horizon lock filter (e.g., the horizon lock filter 504 of FIG. 5), a sphere lock, a target lock, an orbit lock, a tool frame filter, a base frame filter, an axis lock, a rotation filter, a speed filter, a plane lock, or a translation filter applied to the camera. The live-motion filter may be a setting for the camera. Horizon Lock may refer to where the roll is locked to the global frame horizon by fixing the angle between the y-axis of the robot tool frame (the camera) and the z-axis of the robot global frame (the robot base), when the camera is mounted so the lens is parallel to the x-axis of the robot tool frame. In cinematography, camera operators often want their camera parallel to the horizon and to avoid any motion on the roll axis while continuing to yaw (pan) and pitch (tilt). Horizon lock is further expanded to include trajectory generation solutions with user-generated live motion. In user-generated live motion, where the robot path is on-the-fly generated by user interaction with sensors or pressing buttons, the path often is unknown beforehand and is not pre-planned. To prevent camera roll from happening in live motion, a control loop may be implemented to monitor and minimize the change of angle between the y-axis of the robot tool frame (the camera) and the z-axis of the robot global frame (robot base). This control loop may minimize the change in angle by adjusting the on-the-fly robot tool pose. This allows users to set the robot in a mode where the camera does not roll while moving with live motion. The horizon lock technology can be further used to lock other motion besides the horizon, allowing for the fixing of an angle between one of the tool axes in reference to one of the global axes during on-the-fly live motion. This control loop may minimize the change in angle by adjusting the on-the-fly robot tool poses. This allows users to set the robot in a mode where the camera does not roll while moving with live motion. The horizon lock technology can be further used to lock other motion besides the horizon, allowing for the fixing of an angle between one of the tool axes in reference to one of the global axes during on-the-fly live motion.

At block 1206, the device may identify a filter setpoint for the live-motion filter. The setpoint may be a horizon lock angle, a sphere center and radius, etc. A horizon lock angle may be used as a setpoint to determine how to move the robot and/or camera (e.g., FIG. 1, FIGS. 2A-4). The horizon lock angle may be between the Y-axis of the robot tool frame (e.g., the camera) and the Z-axis of the robot global frame (e.g., the robot base). Alternatively, the setpoint may be a sphere radius and center (e.g., FIG. 8).

At block 1208, the device may generate filtered position control data (e.g., the filtered position control data 507 of FIG. 5) for the camera based on the user input, the live-motion filter, and the filter setpoint. For example, in the case of horizon lock, the filtered position control data may filter out any motion that would cause movement in the camera (tool frame) roll axis.

At block 1210, the device may generate joint data for the robot device based on the filtered position control data. The joint data may refer to the position data and movements of the robot's joints to achieve the corresponding filtered positions.

At block 1212, the device may cause the camera to move along a trajectory according the joint data. That is, the robot may move along the trajectory with its joints positioned according to the joint data, causing the camera to move and be oriented accordingly.

At block 1214, optionally, the device may receive feedback data indicative of the robot's actual position in space. Based on the actual position relative to the trajectory, the device may modify the trajectory.

FIG. 12B illustrates a flow diagram of illustrative process 1250 for an illustrative robotic drive control system, in accordance with one or more example embodiments of the present disclosure.

At block 1252, a device (e.g., the robotic device(s) 120 of FIG. 1) may generate keyframes indicating times when a camera (e.g., the device 122 of FIG. 1) and an object (e.g., the object 124 of FIG. 1) are to be positioned at respective locations. The camera's keyframe locations may be taught by the user moving the camera with a wand or other controller to the desired locations and saving the location to the keyframe. The target locations are taught by the user focusing the camera on a desired target and saving this to the target keyframe.

At block 1254, the device may determine a type of path that the camera and/or target is to apply between the keyframes. The type of path may include linear, spline, circular, robot joint-only, or elliptical sections.

At block 1256, the device may determine the times that the camera and/or target will be at respective points of the paths for the camera and/or target.

At 1258, the device may identify a roll restraint applied to the camera, such as synchronized roll, unsynchronized roll, or horizon lock.

At block 1260, the device may generate trajectories for the camera and the target based on the keyframes, the type of path, the times when the camera and the target are to be are to be positioned at the respective locations, an acceleration profile, and the roll restraint. The object and camera trajectories may be defined by the keyframes, which allow a user to indicate when in time they want the target and the camera to be at particular 3D locations in space. The camera's keyframe locations may be taught by the user moving the camera with a wand or other controller to the desired locations and saving the location to the keyframe. The target locations may be taught by the user focusing the camera on a desired target and saving this to the target keyframe.

At block 1262, the device may move the camera and/or target according to the trajectories. Based on the keyframe locations, times, and motion types, the camera may move from one keyframe location to another keyframe location, and may control the camera to maintain camera focus on the target based on the target locations at respective times.

It is understood that the above descriptions are for purposes of illustration and are not meant to be limiting.

FIG. 13 illustrates a block diagram of an example of a robotic machine 1300 or system upon which any one or more of the techniques (e.g., methodologies) discussed herein may be performed. In other embodiments, the robotic machine 1300 may operate as a stand-alone device or may be connected (e.g., networked) to other machines. In a networked deployment, the robotic machine 1300 may operate in the capacity of a server machine, a client machine, or both in server-client network environments. In an example, the robotic machine 1300 may act as a peer machine in peer-to-peer (P2P) (or other distributed) network environments. The robotic machine 1300 may be any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. For example, the robotic machine 1300 may include or represent components of the robotic devices 120, the motion capture input device 123, and/or the controller device 102 of FIG. 1, the handheld component 202 of FIG. 2A, and/or the robot 204 of FIG. 2), allowing a controller device to receive user inputs, translate the inputs into movements, and control movements of the robot by sending corresponding signals for the robot to translate into movements.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

Certain embodiments may be implemented in one or a combination of hardware, firmware, and software. Other embodiments may also be implemented as program code or instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the robotic machine 1300 may include one or more processors and may be configured with program code instructions stored on a computer-readable storage device memory. Program code and/or executable instructions embodied on a computer-readable medium may be transmitted using any appropriate medium including, but not limited to, wireless, wireline, optical fiber cable, RF, etc., or any suitable combination of the foregoing. Program code and/or executable instructions for carrying out operations for aspects of the disclosure may be written in any combination of one or more programming languages, including an object-oriented programming language such as Java, Smalltalk, C++ or the like, and conventional procedural programming languages, such as the “C” programming language or similar programming languages. The program code and/or executable instructions may execute entirely on a device, partly on the device, as a stand-alone software package, partly on the device and partly on a remote device or entirely on the remote device or server.

The robotic machine 1300 may include at least one hardware processor 1302 (e.g., a central processing unit (CPU), a graphics processing unit (GPU), a hardware processor core, or any combination thereof), a main memory 1304, and a static memory 1306. The robotic machine 1300 may include drive circuitry 1318. The robotic machine 1300 may further include an inertial measurement device 1332, a graphics display device 1310, an alphanumeric input device 1312 (e.g., a keyboard), and a user interface (UI) navigation device 1314 (e.g., a mouse). In an example, the graphics display device 1310, the alphanumeric input device 1312, and the UI navigation device 1314 may be a touch screen display. The robotic machine 1300 may additionally include a storage device 1316, a robotic motion control device 1319 (e.g., capable of performing the process 1200 of FIG. 12A and the process 1250 of FIG. 12B), a network interface device/transceiver 1320 coupled to antenna(s) 1230, and one or more sensors 1328. The robotic machine 1300 may include an output controller 1334, such as a serial (e.g., universal serial bus (USB), parallel, or other wired or wireless (e.g., infrared (IR), near field communication (NFC), etc.) connection to communicate with or control one or more peripheral devices. These components may couple and may communicate with each other through an interlink (e.g., bus) 1308. Further, the robotic machine 1300 may include a power supply device that is capable of supplying power to the various components of the robotic machine 1300.

The drive circuitry 1318 may include a motor driver circuitry that operates various motors associated with the axes of the robotic machine 1300. Motors may facilitate the movement and positioning of the robotic machine 1300 around the respective axes for a plurality of degrees of freedom (e.g., X, Y, Z, pitch, yaw, and roll). The motor driver circuitry may track and modify the positions around the axes by affecting the respective motors.

The inertial measurement device 1332 may provide orientation information associated with a plurality of degrees of freedom (e.g., X, Y, Z, pitch, yaw, roll, roll rate, pitch rate, yaw rate) to the hardware processor 1302. The hardware processor 1302 may in turn analyze the orientation information and generate, possibly using both the orientation information and the encoder information regarding the motor shaft positions, control signals for each motor. These control signals may, in turn, be communicated to motor amplifiers to independently control motors to impart a force on the system to move the system. The control signals may control motors to move a motor to counteract, initiate, or maintain rotation.

The hardware processor 1302 may be capable of communicating with and independently sending control signals to a plurality of motors associated with the axes of the robotic machine 1300.

The storage device 1316 may include a machine-readable medium 1322 on which is stored one or more sets of data structures or instructions 1324 (e.g., software) embodying or utilized by any one or more of the techniques or functions described herein. The instructions 1324 may also reside, completely or at least partially, within the main memory 1304, within the static memory 1306, or within the hardware processor 1302 during execution thereof by the robotic machine 1300. In an example, one or any combination of the hardware processor 1302, the main memory 1304, the static memory 1306, or the storage device 1316 may constitute machine-readable media.

The antenna(s) 1330 may include one or more directional or omnidirectional antennas, including, for example, dipole antennas, monopole antennas, patch antennas, loop antennas, microstrip antennas, or other types of antennas suitable for the transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

The robotic motion control device 1319 may carry out or perform any of the operations and processes (e.g., the processes 1200 and 1250) described and shown above.

It is understood that the above are only a subset of what the robotic motion control device 1319 may be configured to perform and that other functions included throughout this disclosure may also be performed by the robotic motion control device 1319.

While the machine-readable medium 1322 is illustrated as a single medium, the term “machine-readable medium” may include a single medium or multiple media (e.g., a centralized or distributed database, and/or associated caches and servers) configured to store the one or more instructions 1324.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random-access memory (RAM), magnetic disk storage media; optical storage media’ a flash memory, etc.

The term “machine-readable medium” may include any medium that is capable of storing, encoding, or carrying instructions for execution by the robotic machine 1300 and that cause the robotic machine 1300 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1324 may further be transmitted or received over a communications network 1326 using a transmission medium via the network interface device/transceiver 1320 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, and peer-to-peer (P2P) networks, among others. In an example, the network interface device/transceiver 1320 may include one or more physical jacks (e.g., Ethernet, coaxial, or phone jacks) or one or more antennas (e.g., antennas 1330) to connect to the communications network 1326. In an example, the network interface device/transceiver 1320 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the robotic machine 1300 and includes digital or analog communications signals or other intangible media to facilitate communication of such software. The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a single input single output (SISO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations. Certain aspects of the disclosure may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.”

The computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A method, comprising:
receiving, by at least one processor of a robot device, a user input to control a camera operatively connected to the robot device;
identifying a live-motion filter applied to the camera;
identifying a filter setpoint associated with the live-motion filter;
generating filtered position control data for the camera based on the user input, the live-motion filter, and the filter setpoint;
generating joint data for the robot device based on the filtered position control data; and
causing the camera to move according to the joint data.

2. The method of claim 1, wherein the live-motion filter is a horizon lock, a sphere lock, a target lock, an orbit lock, a plane lock, a tool frame filter, a base frame filter, an axis lock, a rotation filter, a speed filter, or a translation filter

3. The method of claim 1, further comprising:
generating keyframes indicating times when the camera and an object are to be positioned at respective locations;
determining a type of path to apply to movement of the camera and the object, wherein the object remains in a field of view of the camera during the movement;
determining an acceleration profile to apply to the movement of the camera and the object; and
generating a trajectory for the camera based on the keyframes, the type of path, the times, and the acceleration profile,
wherein causing the camera to move is based on the trajectory.

4. The method of claim 3, further comprising:
identifying, based on the keyframes, a first location of the object at a first time;
identifying, based on the keyframes, a second location of the robot device at the first time; and
determining, based on an axis spanning from a lens of the camera to the object at the first time, an orientation for the robot device, the orientation associated with maintaining the object centered from the perspective of the camera while moving the camera based on the trajectory; and
determining, based on a distance of the camera to the object at the first time, a focal distance associated with maintaining the object in focus from the perspective of the camera while moving the camera based on the trajectory.

5. The method of claim 3, wherein causing the camera to move based on the trajectory comprises:
causing the robot device to decelerate, based on the acceleration profile, when the robot device is proximal to a first keyframe of the keyframes while moving from a second keyframe of the keyframes to the first keyframe; and
causing the robot device to accelerate, based on the acceleration profile, when the robot device is proximal to the first keyframe while moving from the first keyframe to a third keyframe of the keyframes,
wherein the camera moves continuously between the second keyframe and the third keyframe.

6. The method of claim 3, wherein to move the camera based on the trajectory comprises to move the camera further based on at least one of a synchronized roll restraint, an unsynchronized roll restraint, or a horizon lock roll restraint.

7. The method of claim 3, wherein the keyframes comprise a first keyframe, a second keyframe, and a third keyframe, the second keyframe being in between the first keyframe and the third keyframe, the method further comprising:
generating, based on the first keyframe, the second keyframe, and the third keyframe, a fourth keyframe to replace the second keyframe in the trajectory,
wherein the fourth keyframe is associated with at least one of a circular trajectory or a spline trajectory as the robot device approaches the fourth keyframe from the first keyframe and moves away from the fourth keyframe to the third keyframe.

8. The method of claim 3, wherein the keyframes comprise a first keyframe, a second keyframe, and a third keyframe, the second keyframe being in between the first keyframe and the third keyframe, wherein the trajectory is linear between the first keyframe and the second keyframe, wherein the trajectory is non-linear between the second keyframe and the third keyframe, and wherein the camera moves continuously between the first keyframe and the third keyframe.

9. The method of claim 1, further comprising:
generating feedback data indicative of a position of the robot device; and
generating a trajectory based on the feedback data,
wherein causing the camera to move is further based on the trajectory.

10. A robotic device, the robotic device comprising processing circuitry coupled to storage, the processing circuitry configured to:
receive a user input to control a camera operatively connected to the robotic device;
identify a live-motion filter applied to the camera;
identify a filter setpoint associated with the live-motion filter;
generate filtered position control data for the camera based on the user input, the live-motion filter, and the filter setpoint;
generate joint data for the robotic device based on the filtered position control data; and
cause the camera to move according to the joint data.

11. The robotic device of claim 10, wherein the live-motion filter is a horizon lock, a sphere lock, a target lock, an orbit lock, a plane lock, a tool frame filter, a base frame filter, an axis lock, a rotation filter, a speed filter, or a translation filter.

12. The robotic device of claim 10, wherein the processing circuitry is further configured to:
generate keyframes indicating times when the camera and an object are to be positioned at respective locations;
determine a type of path to apply to movement of the camera and the object, wherein the object remains in a field of view of the camera during the movement;
determine an acceleration profile to apply to the movement of the camera and the object; and
generate a trajectory for the camera based on the keyframes, the type of path, the times, and the acceleration profile,
wherein to cause the camera to move is based on the trajectory.

13. The robotic device of claim 12, wherein the processing circuitry is further configured to:
identify, based on the keyframes, a first location of the object at a first time;
identify, based on the keyframes, a second location of the robotic device at the first time;
determining, based on an axis spanning from a lens of the camera to the object at the first time, an orientation for the robot device, the orientation associated with maintaining the object centered from the perspective of the camera while moving the camera based on the trajectory; and
determining, based on a distance of the camera to the object at the first time, a focal distance associated with maintaining the object in focus from the perspective of the camera while moving the camera based on the trajectory.

14. The robotic device of claim 12, wherein to cause the camera to move based on the trajectory comprises to:
cause the robotic device to decelerate, based on the acceleration profile, when the robotic device is proximal to a first keyframe of the keyframes while moving from a second keyframe of the keyframes to the first keyframe; and
cause the robotic device to accelerate, based on the acceleration profile, when the robotic device is proximal to the first keyframe while moving from the first keyframe to a third keyframe of the keyframes,
wherein the camera moves continuously between the second keyframe and the third keyframe.

15. The robotic device of claim 12, wherein to cause the camera to move based on the trajectory comprises to cause the camera to move further based on at least one of a synchronized roll restraint, an unsynchronized roll restraint, or a horizon lock roll restraint.

16. The robotic device of claim 12, wherein the keyframes comprise a first keyframe, a second keyframe, and a third keyframe, the second keyframe being in between the first keyframe and the third keyframe, wherein the processing circuitry is further configured to:
generate, based on the first keyframe, the second keyframe, and the third keyframe, a fourth keyframe to replace the second keyframe in the trajectory,
wherein the fourth keyframe is associated with a circular trajectory or a spline trajectory as the robotic device approaches the fourth keyframe from the first keyframe and moves away from the fourth keyframe to the third keyframe.

17. The robotic device of claim 12, wherein the keyframes comprise a first keyframe, a second keyframe, and a third keyframe, the second keyframe being in between the first keyframe and the third keyframe, wherein the trajectory is linear between the first keyframe and the second keyframe, wherein the trajectory is non-linear between the second keyframe and the third keyframe, and wherein the camera moves continuously between the first keyframe and the third keyframe.

18. A system comprising:
a robotic device comprising processing circuitry coupled to memory; and
a camera operatively attached to the robotic device,
wherein the processing circuitry is configured to:
generate keyframes indicating times when the camera and an object are to be positioned at respective locations;
determine a type of path to apply to movement of the camera and the object, wherein the object remains in a field of view of the camera during the movement;
determine an acceleration profile to apply to the movement of the camera and the object; and
generate a trajectory for the camera based on the keyframes, the type of path, the times, and the acceleration profile,
wherein to cause the camera to move is based on the trajectory.

19. The system of claim 18, wherein to cause the camera to move based on the trajectory comprises to:
cause the robot device to decelerate, based on the acceleration profile, when the robot device is proximal to a first keyframe of the keyframes while moving from a second keyframe of the keyframes to the first keyframe; and
cause the robot device to accelerate, based on the acceleration profile, when the robot device is proximal to the first keyframe while moving from the first keyframe to a third keyframe of the keyframes,
wherein the camera moves continuously between the second keyframe and the third keyframe.

20. The system of claim 18, wherein to move the camera based on the trajectory comprises to move the camera further based on at least one of a synchronized roll restraint, an unsynchronized roll restraint, or a horizon lock roll restraint.
